(19) United States
(12) Patent Application Publication
(10) Pub. No.: US 2010/0082497 A1
(43) Pub. Date: Apr. 1, 2010

(54) Providing Foundation Application as Enterprise Services

(75) Inventors: Thomas Biesemann, Bad Schoenbom (DE); Dieter Krisch, Karlsruhe (DE); Volker Schott, Nussloch (DE); Michael Meyringer, Rauenberg (DE); Otfried Von Geisau, Sinsheim (DE); Martin Haerterich, Wiesloch (DE); Ralf Becker, Mannheim (DE); Ingo Bruss, Heidelberg (DE); Horst Schaude, Kraichtal (DE); Silke Storch, Rauenberg (DE); Klaus Bahr, Karlsruhe (DE); Volker Faisst, Ilvesheim (DE); Ralph Moessner, Pfinztal (DE); Vsevolod Barabanov, Rauenberg (DE); Andreas Kasparek, Schwetzingen (DE); Jens Griessmann, Walldorf (DE); Hendrik Geipel, Walldort (DE); Frank Lindqvist, Reilingen (DE); Oliver Grande, Heidelberg (DE); Ute Dittmann, Heidelberg (DE); Ricardo Padilha, Karlsruhe (DE); Martin Walla, Heidelberg (DE); Joachim Puteick, Ubstadt-Weiher (DE); Daniel Zimmermann, Sandhausen (DE); Thomas Schneider, Heidelberg (DE); Tilmann Haeberle, Wiesloch (DE); Gerald Krause, Lorsch (DE); Karl-Peter Nos, Nussloch (DE); Peter Schwarze, Sinsheim Duehren (DE); Daniel Maring, Reichstett (FR); Yongbin He, Schriesheim (DE); Martina Lahr, Weinheim (DE); Ingo Pfitzner, Berlin (DE); Shadab Shafiq, New Delhi (IN); Christian Haas, Heidelberg (DE); Olaf Schulte, Walldorf (DE); Christoph Lehner, Heidelberg (DE); Dietmar Storz, Heidelberg (DE); Joachim Barnbeck, Heidelberg (DE); Bernhard May, Merzig (DE); Andrea Sudbrack, Heidelberg (DE); Michael Wachter, Hockenheim (DE); Thomas Kretz, Muehlhausen (DE); Monika Kaiser, Bad Schoenbom (DE); Andreas Steiner, Leimen (DE); Gurmeet Singh Dhingra, Bangalore (IN); Andreas Huppert, Neulussheim (DE); Ashwin Reddy Yeddula, Walldorf (DE); Keshav B. Desal, Bangalore (IN); Tobias Traxel, Walzbachtal-Joehlingen (DE); Kranthi Kumar Muppala, London (GB); Muttanna Sarashetti, Karnataka (IN); Kritesh Vasing, Bangalore (IN); Kai-Uwe Pielka, Reilingen (DE); Raja Krishnamoorthy, Bangalore (IN); Jyotsna Sharma, Bangalore (IN); Mohit V. Gadkari, Bangalore (IN); Mukesh Kumar, Bangalore (IN); Toralf Grossmann, Wiesloch (DE); Andreas Neumann, St. Leon-Rot (DE); Fabian Guenther, Mauer (DE); Jens Ruths, Wiesloch (DE); Matthias Richter, Sinsheim (DE); Walter Koller, Bad Schoenbom (DE); Philipp Suenderhauf, Leimen (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 12/233,530

(22) Filed: Sep. 18, 2008

(51) Int. Cl. G06Q 10/00; G06Q 50/00

(52) U.S. Cl. 705/301

(57) ABSTRACT

Methods and apparatus, including systems and computer program products, for a services architecture design that provides enterprise services having foundation layer functionality at the level of an enterprise application. The design includes a set of service operations, process components, and optionally deployment units. Suitable business objects are also described.

### BACKGROUND

This specification relates to data processing systems implemented on computers, and, more particularly, to data processing systems providing services in the nature of web services.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

Web services are one technology for making the functionality of software applications available to other software, including other applications. A web service is a standards-based way of encapsulating the functionality of an application that other applications can locate and access. A service-oriented architecture is a distributed software model within which functionality is defined as independent web services. Within a service-oriented architecture, web services can be used in defined sequences according to business logic to form applications that enable business processes.

### SUMMARY

This specification describes the foundation layer for a services architecture design for implementing services-based applications having various functionality at the level of an enterprise application.

In its various aspects, the invention can be embodied in systems, methods, and computer program products. For example, a system in one embodiment implements a services architecture design that provides foundation layer functionality for enterprise applications. The design includes service operations, data objects, and process components. Business objects can also be included. Particular embodiments can be replicated and synchronized on multiple computer hardware platforms that are distinct and separate from each other to support a software application deployed in distinct aspects on the separate hardware platforms.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIGS. 1A, 1B, 1C, 1D, 1E, 1F, 1G, 1H, 1I, 1J, 1K, 1L, 1M, 1N, 1O, 1P, and 1Q collectively illustrate a foundation layer in accordance with one implementation of the invention.

FIG. 2 illustrates a deployment of the foundation layer of FIGS. 1A, 1B, 1C, 1D, 1E, 1F, 1G, 1H, 1I, 1J, 1K, 1L, 1M, 1N, 1O, 1P, and 1Q in accordance with one implementation of the invention.

FIG. 3 is a block diagram showing a software problem reporting process component.

FIGS. 4A-4C are block diagrams showing an organizational management process component.

FIG. 5 is a block diagram showing an interaction in a date and time process component.

FIG. 6 is a block diagram showing an input and output management process component.

FIG. 7 is a block diagram showing an interaction with a payment authorization process component.

FIGS. 8A-B are block diagrams showing a product property management process component.

FIG. 9 is a block diagram showing an identity management process component.

FIGS. 10A-B are block diagrams showing a product data maintenance process component.

FIGS. 11A-B are block diagrams showing a business partner data management process component.

FIG. 12 is a block diagram showing an inspection master data management process component.

FIG. 13 is a block diagram showing a payment master data management process component.

FIG. 14 is a block diagram showing an interaction with an accounting coding block distribution processing process component.

FIG. 15 is a block diagram showing a document management process component.

FIG. 16 is a block diagram showing a quantity conversion process component.

FIG. 17 is a block diagram showing a data flow verification process component.

FIG. 18 is a block diagram showing a business document flow processing process component.

### DETAILED DESCRIPTION

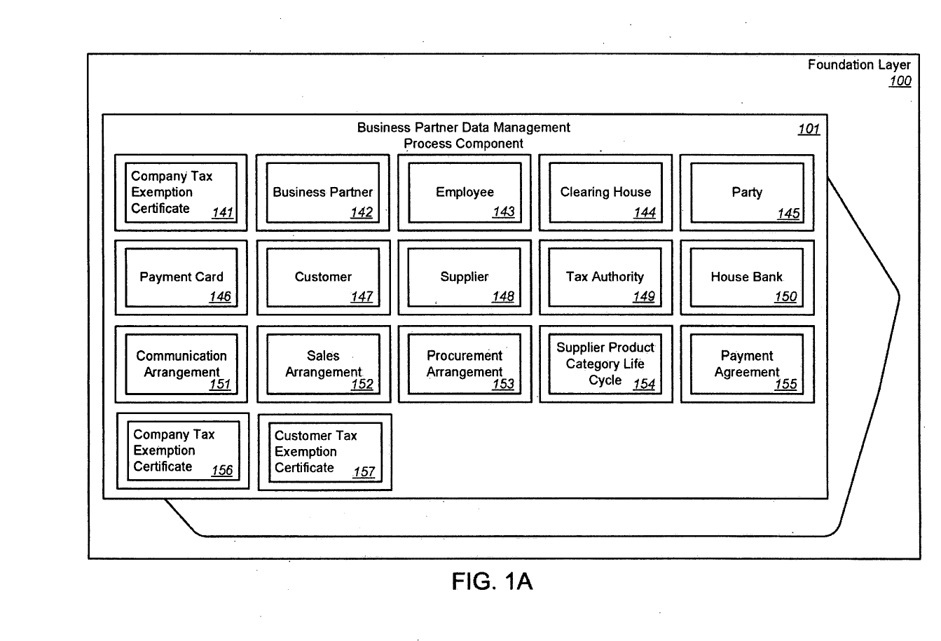

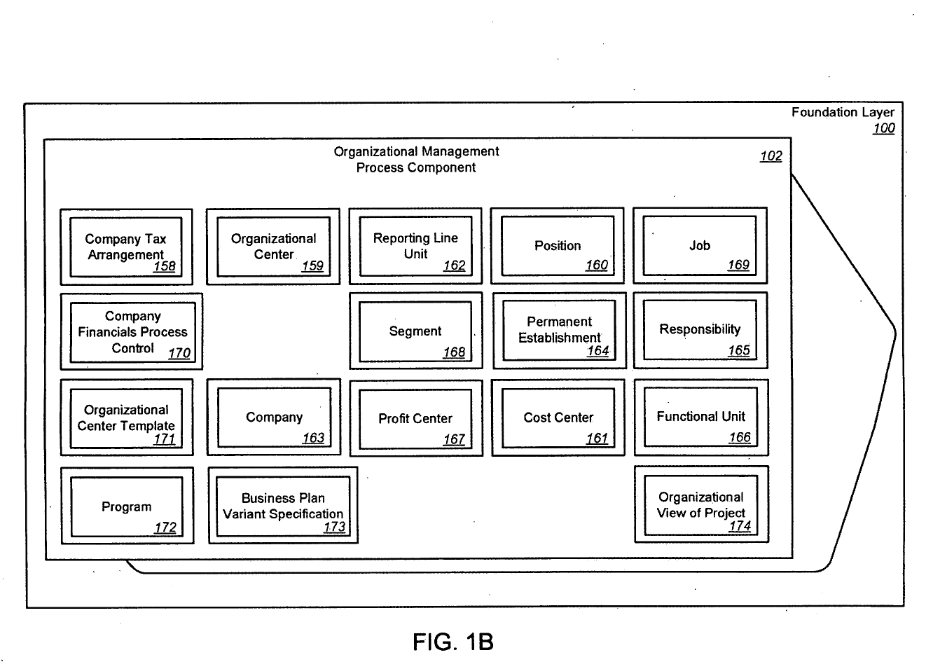

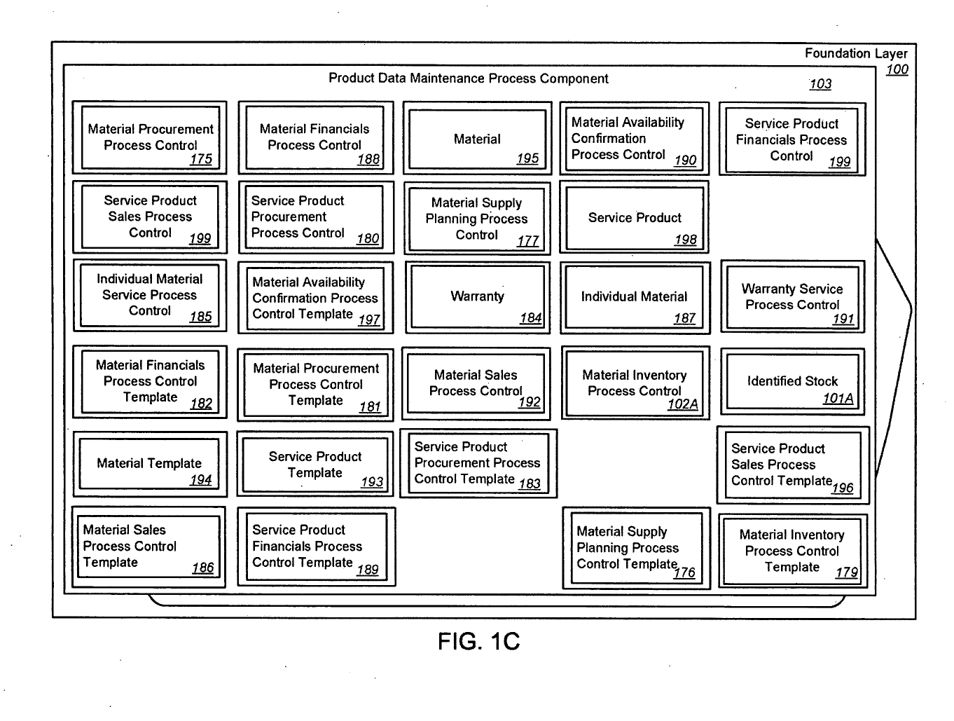

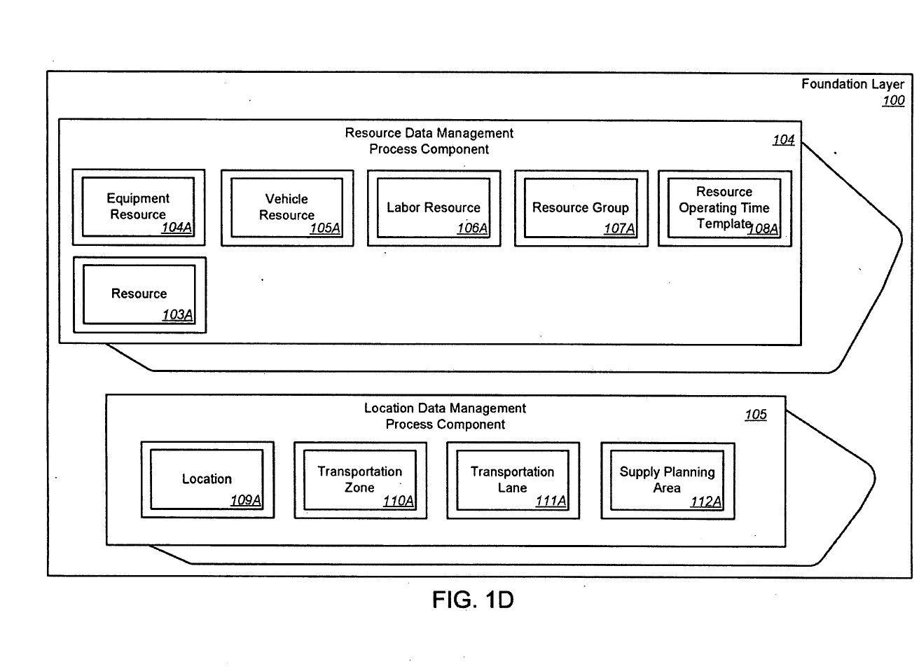

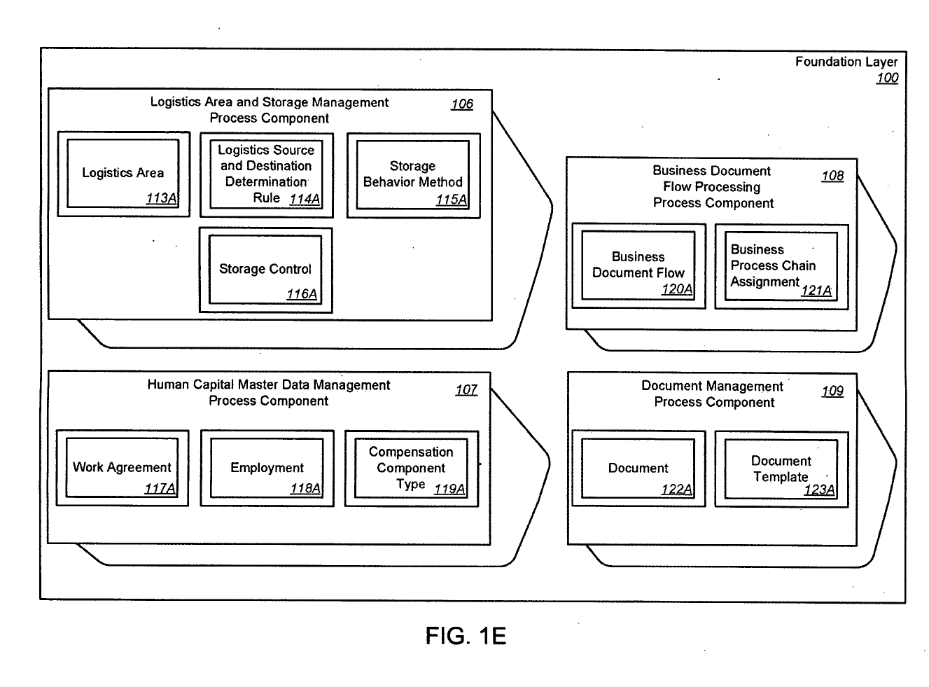

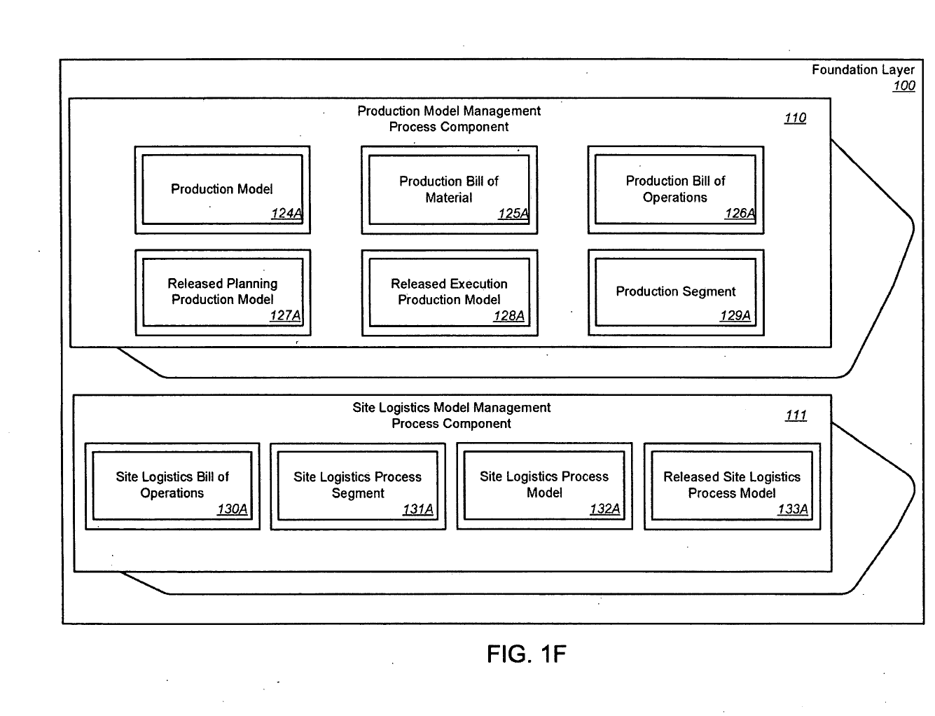

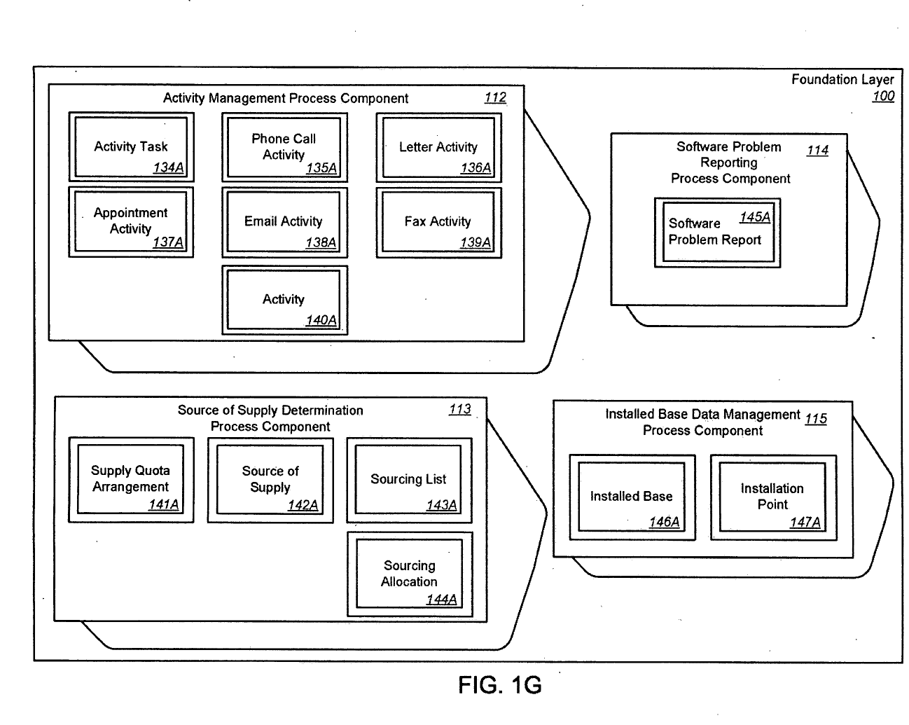

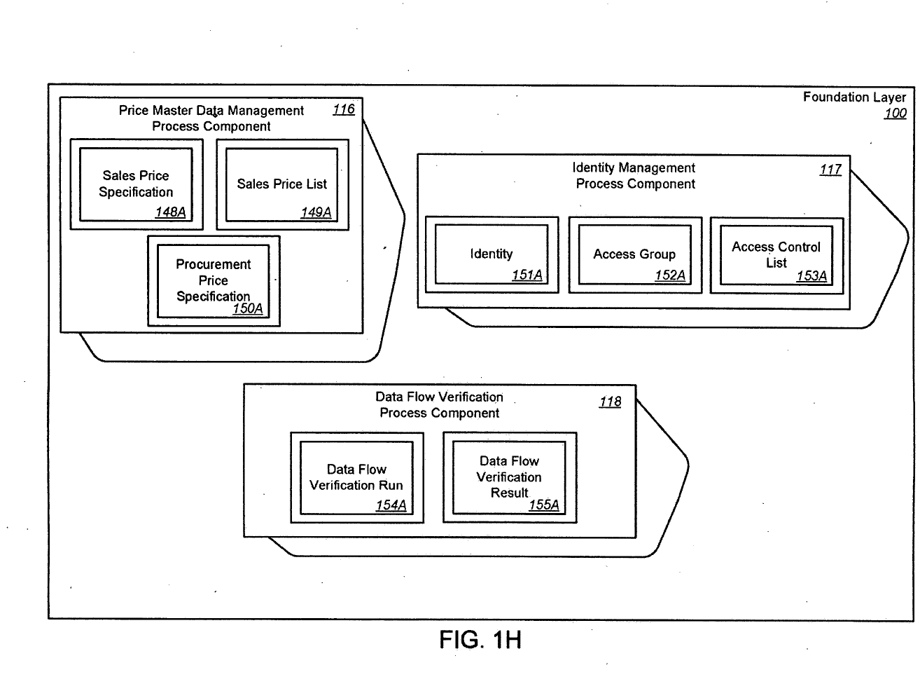

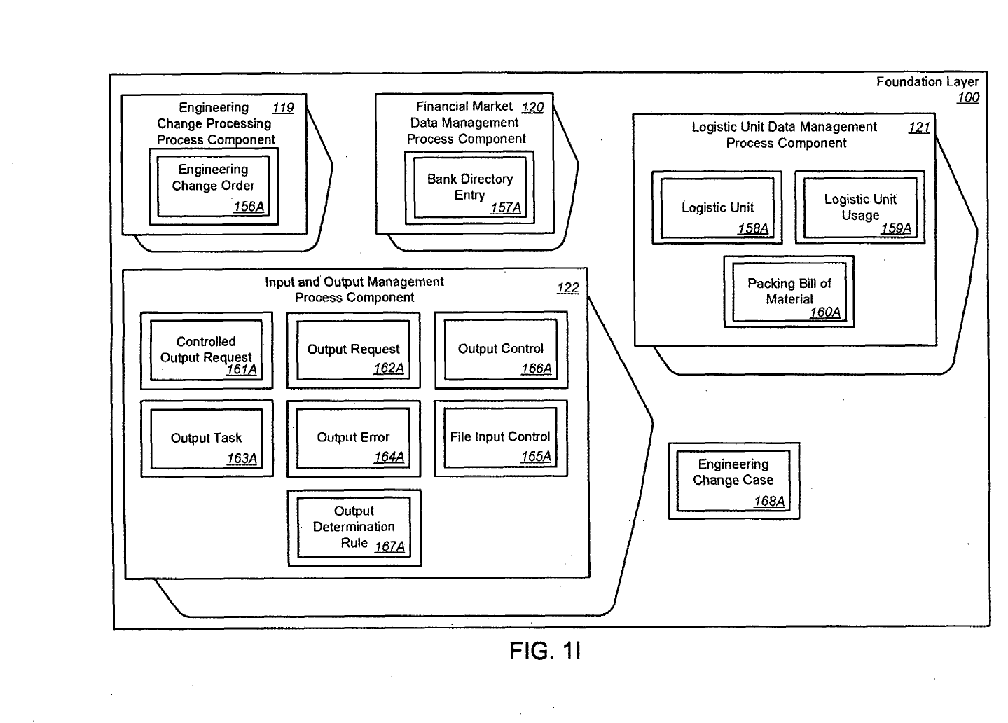

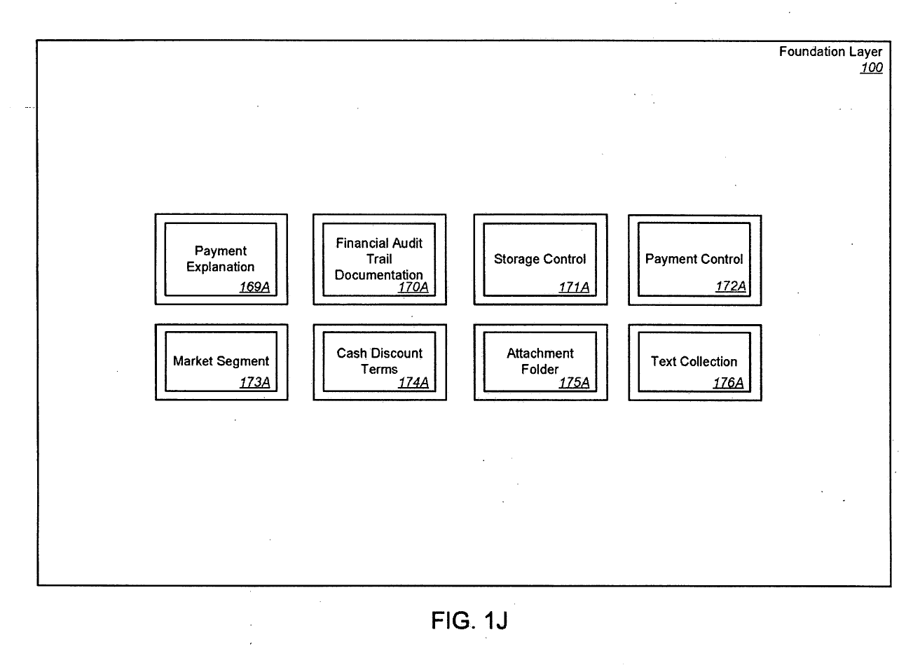

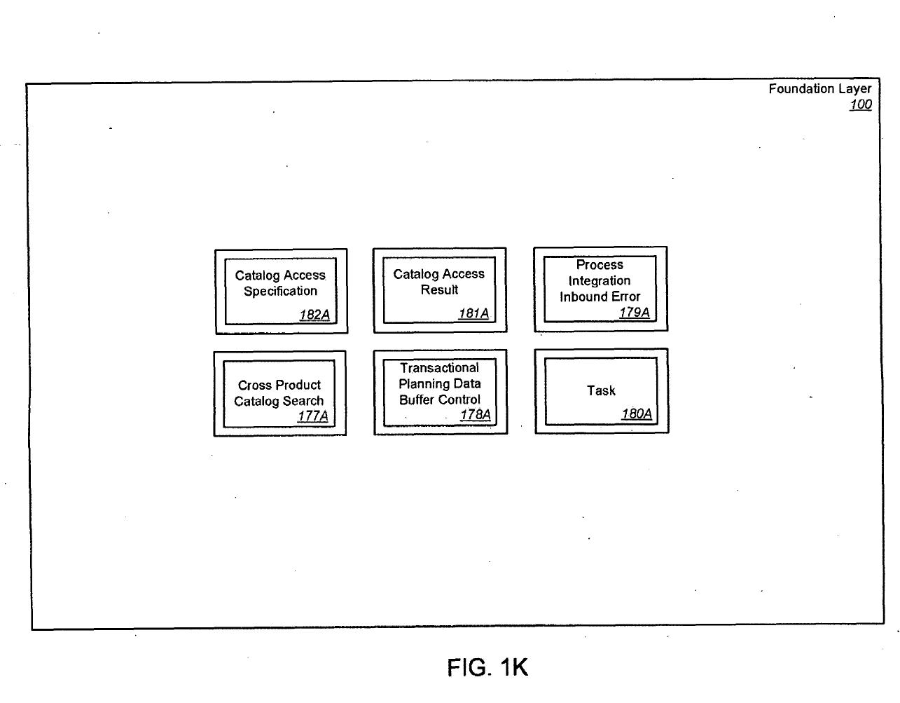

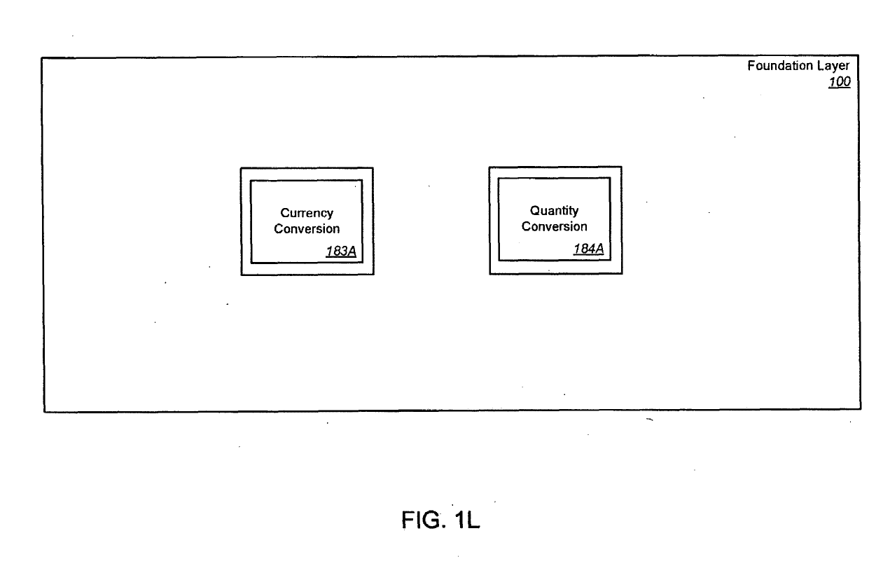

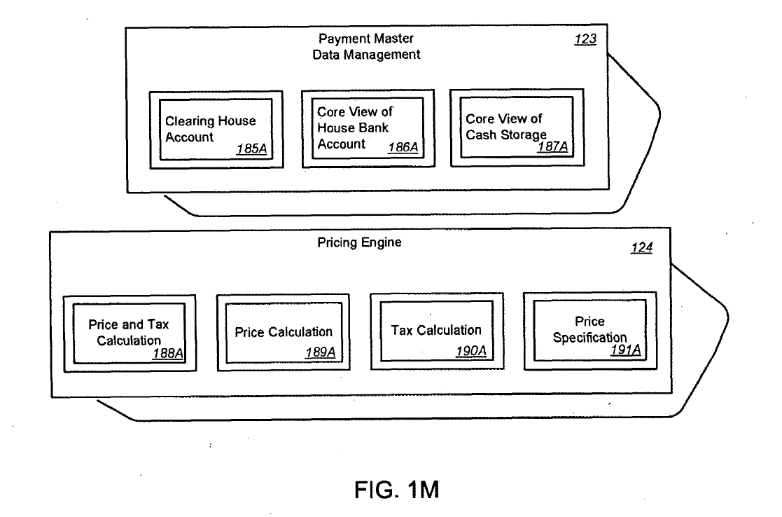

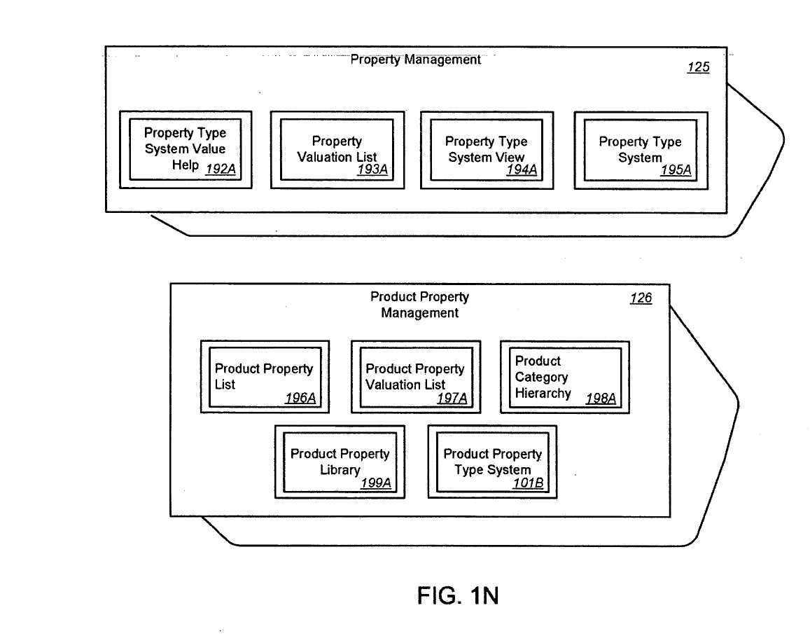

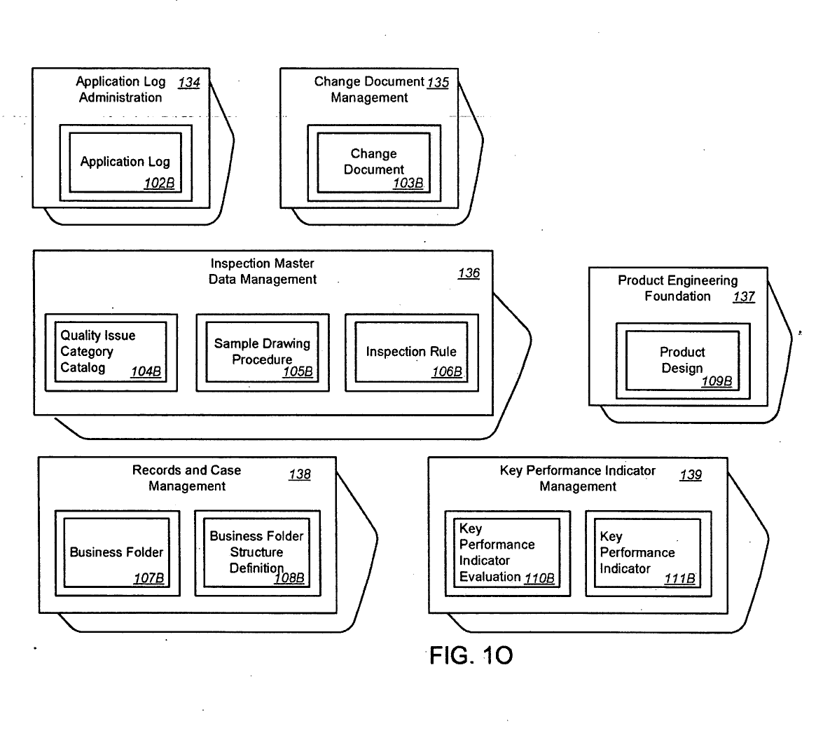

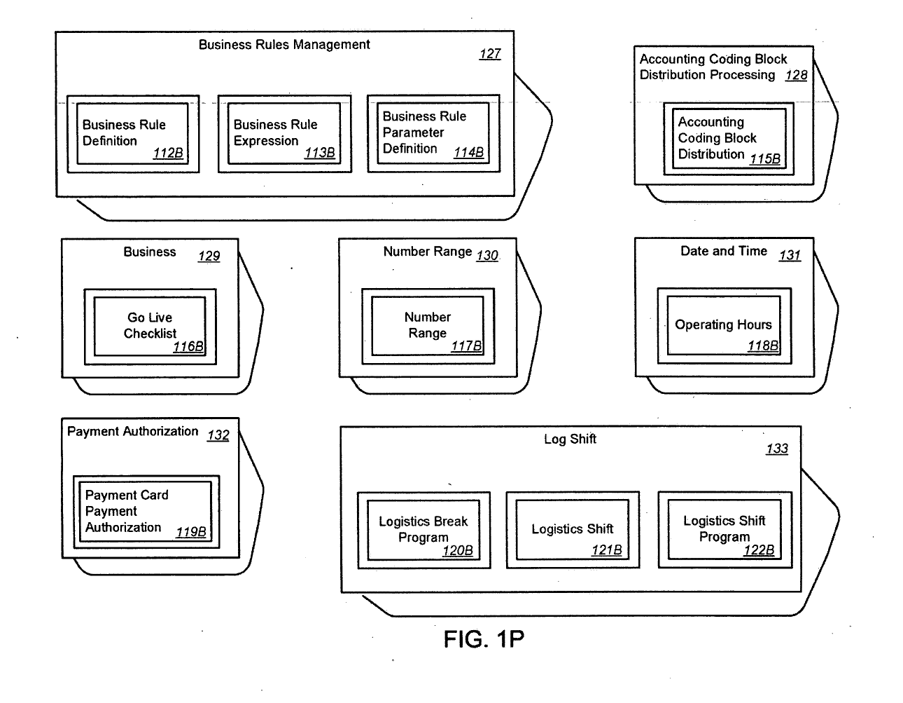

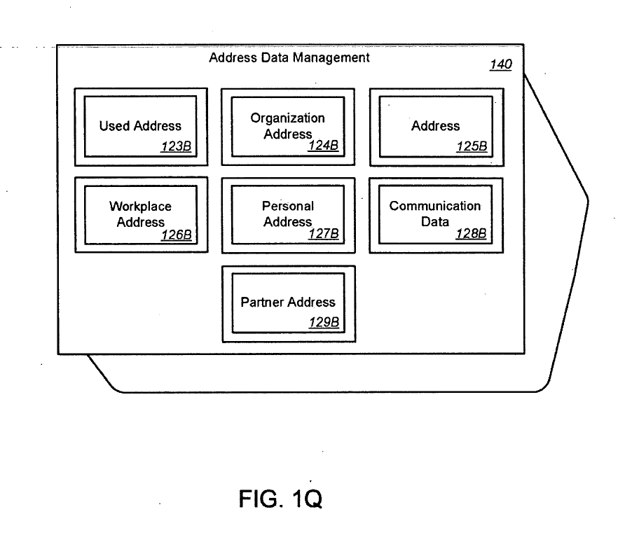

FIGS. 1A, 1B, 1C, 1D, 1E, 1F, 1G, 1H, 1I, 1J, 1K, 1L, 1M, 1N, 1O, 1P, and 1Q collectively illustrate a foundation layer 100 in accordance with one implementation of the invention. The foundation layer can be used to support application software deployed in an application layer. In particular, the foundation layer can be used in connection with application software implemented in accordance with a software architecture that provides a suite of enterprise service operations having various application functionality.

The elements of the architecture include the business object, the process component, the service operation (or simply, the operation), the service interface, the message, and the deployment unit. The elements can also include process agents and reuse service components. These will be generally described below.

In some implementations, the application software is implemented to be deployed on an application platform that includes a foundation layer that contains all fundamental entities that can be used from multiple deployment units. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

The elements of the architecture can be implemented to realize a software application that implements enterprise application service interfaces. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, and instances of business objects include content, which a typical business user would expect and understand with little explanation. Whether an object as a type or an instance of an object is intended by the term “object” is generally clear from the context, so the distinction will be made explicitly only when necessary. Also, for convenience and brevity, an object instance may be described in this specification as being or including a real world event, activity, item, or the like; however, such description should be understood as stating that the object instance represents (i.e., contains data representing) the respective event, activity, item, or the like. Properly implemented, business objects are implemented free of redundancies.

Business objects are further categorized as business process objects, master data objects, mass data run objects, dependent objects, and transformed objects. A master data object is an object that encapsulates master data (i.e., data that is valid for a period of time). A business process object, which is the kind of business object generally found in a process component, is an object that encapsulates transactional data (i.e., data that is valid for a point in time). A mass data run object is an application object that executes an algorithm for a particular mass data run, and generally has a name that includes “run.” An instance of a mass data run object embodies or contains a particular set of selections and parameters. A mass data run object implements an algorithm that modifies, manages, and/or processes a large amount of data in multiple transactions, possibly but not necessarily with parallel processing. A dependent object is a business object used as a reuse part in another business object. A dependent object represents a concept that cannot stand by itself from a business point of view. Instances of dependent objects only occur in the context of a non-dependent business object. A transformed object is a transformation of multiple business objects for a well-defined purpose. It transforms the structure of multiple business objects into a common structure. A transformed object does not have own persistency.

The architectural elements also include the process component. A process component is a software package that realizes a business process and generally exposes its functionality as services. The functionality includes the ability to perform all or parts of particular kinds of business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters, or some combination of them, serving as a signature. For convenience in supporting use of the operations supported by a system implementing elements of the design, such a system can optionally include a repository of service descriptions that includes a standards-based description of each of the supported service operations.

The architectural elements also optionally include the service interface, which may be referred to simply as an interface. An interface is a named group of operations. Each operation belongs to exactly one interface. An interface belongs to exactly one process component. A process component might implement multiple interfaces. In some implementations, an interface will have only inbound or outbound operations, but not a mixture of both. One interface can include both synchronous and asynchronous operations. All operations of the same type (either inbound or outbound) which belong to the same message choreography will preferably belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An outbound process agent will generally perform some processing of the data of the business object instance whose change triggered the agent or caused the agent to be called. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components and, optionally, one or more business objects, that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interactions (i.e., interactions between process components involving their respective business objects, operations, interfaces, and messages) within other deployment units. Similarly, process components that interact with other process components or external systems only through messages, e.g., as sent and received by operations, can also be replaced as long as the replacement supports the operations of the original.

Interactions between process components that occur only within a deployment unit are not constrained to using service operations. These can be implemented in any convenient fashion.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer are generally master data objects. In addition, the foundation layer may include some business process objects that are used by multiple deployment units. Master data objects and business process objects that should be specific to a deployment unit should be assigned to their respective deployment unit.

FIGS. 1A, 1B, 1C, 1D, 1E, 1F, 1G, 1H, 1I, 1J, 1K, 1L, 1M, 1N, 1O, 1P, and 1Q collectively illustrate a foundation layer in accordance with one implementation of the invention. The Foundation Layer 100 includes a Business Partner Data Management process component 101, an Organizational Management process component 102, a Product Data Maintenance process component 103, a Resource Data Management process component 104, a Location Data Management process component 105, a Logistics Area and Storage Management process component 106, a Human Capital Master Data Management process component 107, a Business Document Flow Processing process component 108, a Document Management process component 109, a Production Model Management process component 110, a Site Logistics Model Management process component 111, an Activity Management process component 112, a Source of Supply Determination process component 113, a Software Problem Reporting process component 114, an Installed Base Data Management process component 115, a Price Master Data Management process component 116, an Identity Management process component 117, a Data Flow Verification process component 118, an Engineering Change Processing process component 119, a Financial Market Data Management process component 120, a Logistic Unit Data Management process component 121, an Input and Output Management process component 122, a Payment Master Data Management process component 123, a Pricing Engine process component 124, a Property Management process component 125, a Product Property Management process component 126, a Business Rules Management process component 127, an Accounting Coding Block Distribution Processing process component 128, a Business process component 129, a Number Range process component 130, a Date and Time process component 131, a Payment Authorization process component 132, a Logistics Shift process component 133, an application log administration process component 134, a change document management process component 135, an Inspection Master Data Management process component 136, a Product Engineering Foundation process component 137, a Records and Case Management process component 138, a Key Performance Indicator Management process component 139, and an Address Data Management process component 140.

The Business Partner Data Management process component 101 (FIG. 1A) manages the business partner master data of a company containing information used to describe the rights and obligations of a business partner participating in various business processes such as sales, purchasing and accounting processes. The Business Partner Data Management process component 101 includes: a Company Tax Exemption Certificate master data object 141, a Business Partner master data object 142, an Employee master data object 143, a Clearing House master data object 144, a Party transformed object 145, a Payment Card master data object 146, a Customer master data object 147, a Supplier master data object 148, a Tax Authority master data object 149, a House Bank master data object 150, a Communication Arrangement master data object 151, a Sales Arrangement master data object 152, a Procurement Arrangement master data object 153, a Supplier Product Category Life cycle master data object 154, a Payment Agreement master data object 155, a Company Tax Arrangement master data object 156, and a Customer Tax Exemption Certificate 157.

The Company Tax Exemption Certificate master data object 141 represents a certificate issued by a company to a supplier claiming exemption from product tax for purchases. The Business Partner master data object 142 represents a person, organization or group of persons or organizations in which a company has a business interest. The Employee master data object 143 represents a person who contributes or has contributed to the creation of goods or services for a company, and can describe “internal” employees and/or “external” employees. Unlike externals, an internal employee is in a position of subordination to another's authority. The Clearing House master data object 144 represents an organization that provides services for the settlement of payment card payments, such as the authorization of payments. The Party transformed object 145 represents a person, an organization, an organizational center, or a group of persons, in which a company has a business interest. The Payment Card master data object 146 represents an issued identification card that can enable the card holder to achieve cashless payments for invoices to an accepting company (e.g., a merchant). The Customer master data object 147 represents a business partner with whom a business relationship exists. The Supplier master data object 148 represents a business partner who provides materials and/or services. The Tax Authority master data object 149 represents a business partner for value added tax declaration. The House Bank master data object 150 represents a business partner providing services for a company, such as account management or lock box. The Communication Arrangement master data object 151 represents an arrangement between the system owner and a business partner, containing the communication settings for XML messaging, file-based communication and form-based communication via output channels like print, email and fax. The Sales Arrangement master data object 152 represents an arrangement that is made by a sales unit for a customer, and is used for sales transactions. The arrangement can include, for example, terms of payment, invoice currency, and incoterms. The arrangement can optionally constitute a contract with a customer. The Procurement Arrangement master data object 153 represents an arrangement used to control procurement transactions, which can be established between a supplier and a purchasing unit, but also for one supplier across all purchasing units. The Supplier Product Category Life Cycle master data object 154 represents a supplier life cycle that contains information about the status of supplier development and the product category delivered by that supplier. The Payment Agreement master data object 155 represents the agreement between a company and a business partner concerning the handling of payments. The Company Tax Exemption Certificate master data object 156 represents a certificate issued by a company to a supplier claiming exemption from product tax for purchases. The Customer Tax Exemption Certificate 157 represents a certificate sent by a customer to a company claiming exemption from tax on sales/purchases.

The Organizational Management process component 102 (FIG. 1B) provides central and unified organizational structures of the enterprise and its collaborative partners. The Organizational Management process component 102 includes: a Company Tax Arrangement master data object 158, an Organizational Center master data object 159, a Position master data object 160, a Cost Center master data object 161, a Reporting Line Unit master data object 162, a Company master data object 163, a Permanent Establishment master data object 164, a Responsibility master data object 165, a Functional Unit master data object 166, a Profit Center master data object 167, a Segment master data object 168, a Job master data object 169, a Company Financials Process Control master data object 170, an Organizational Center Template master data object 171, a Program master data object 172, a Business Plan Variant Specification master data object 173, and an Organizational View of Project master data object 174. The Company Tax Arrangement master data object 158 represents an agreement between a company and a tax authority regarding the declaration and payment of taxes. The Organizational Center master data object 159 represents a business unit within an organizational structure (e.g., organizational plan, financial structure, geographical structure) of a company within the extended enterprise. The data object can incorporate different business roles that are defined in detail by specializing the organizational center into business characters. The Position master data object 160 represents an organizational element within the organizational plan of an enterprise, and can permanently combines tasks, competencies and responsibilities that can be taken care of by one or more suitable employees. The Cost Center master data object 161 represents an organizational unit that represents a defined location of cost incurrence and for which costs are recorded separately. The Reporting Line Unit master data object 162 represents the organizational unit in the personnel reporting line of the enterprise. The reporting line unit can typically have a personnel manager who is responsible for defining the objectives and salaries of the directly or indirectly assigned holders. The Company master data object 163 represents a financially and legally independent, locally unbound entity registered under business law. The Permanent Establishment master data object 164 represents an organizational unit that represents a localized subdivision of a company whose business activities are subject to uniform fiscal treatment. The Responsibility master data object 165 represents an assignment of an agent responsible to a parameter set describing the agent's duty within a certain responsibility type. The Functional Unit master data object 166 represents an organizational center responsible for the planning, execution and administration of business process steps. The responsibility can be performed by the organizational center itself, or it can be delegated. The Profit Center master data object 167 represents an organizational unit that represents a company area for which a separate period-based result for profit-oriented rating is determined. The Segment master data object 168 represents a business branch of a company for which a closing statement (e.g., a financial statement and a profit and loss statement) is to be created based on the segment reporting regulations within the context of the particular accounting principle (e.g., IAS, US-GAAP, or HGB). The Job master data object 169 represents the type of a position, such as task description, task profile, competencies, responsibilities, required qualifications and skill profiles. The Company Financials Process Control master data object 170 represents information about a company that is used in financial processes. In particular, it contains the assignment of departments that are responsible for the planning, the execution, and the monitoring of financials processes of a company. The Organizational Center Template master data object 171 represents a business unit in an organizational structure of a company within the extended enterprise. The Program master data object 172 represents an organizational center for managing a group of subprograms and projects. A program represents a complex, time-restricted set of activities for achieving high-level goals in the context of an extensive company strategy. The Business Plan Variant Specification master data object 173 represents a specification of external business conditions, business assumptions, business goals, and procedures of data collection for a business plan. For example, different business variant specifications based on optimistic, conservative, or pessimistic assumptions can be used in parallel. The Organizational View of Project master data object 174 represents the representation of the organizational data of a project.

The Product Data Maintenance process component 103 (FIG. 1C) enables a company to manage all product data that describes its tangible and intangible products and that is used to control its business processes, such as sales, purchasing, planning, production and accounting processes. The Product Data Maintenance process component 103 includes: a Material Procurement Process Control master data object 175, a Material Supply Planning Process Control Template master data object 176, a Material Supply Planning Process Control master data object 177, a Service Product Financials Process Control master data object 178, a Material Inventory Process Control Template master data object 179, a Service Product Procurement Process Control master data object 180, a Material Procurement Process Control Template master data object 181, a Material Financials Process Control Template master data object 182. a Service Product Procurement Process Control Template master data object 183, a Warranty master data object 184, an Individual Material Service Process Control master data object 185, a Material Sales Process Control Template master data object 186, an Individual Material master data object 187, a Material Financials Process Control master data object 188, a Service Product Financials Process Control Template master data object 189, a Material Availability Confirmation Process Control master data object 190, a Warranty Service Process Control master data object 191, a Material Sales Process Control master data object 192, a Service Product Template master data object 193, a Material Template master data object 194, a Material master data object 195, a Service Product Sales Process Control Template master data object 196, a Material Availability Confirmation Process Control Template master data object 197, a Service Product master data object 198, a Service Product Sales Process Control master data object 199, an Identified Stock master data object 101A, and a Material Inventory Process Control master data object 102A.

The Material Procurement Process Control master data object 175 represents a process-driven view that contains information about a material that is used in procurement-relevant processes. The Material Supply Planning Process Control Template master data object 176 represents a template that simplifies the maintenance of material master data used to control procurement planning Planning is performed at supply planning area level (including specifications for lot-size planning, requirement consumption, in-house production. The Material Supply Planning Process Control master data object 177 represents a process-driven view that contains information about a material that uses the material in supply planning processes. The Service Product Financials Process Control master data object 178 represents a process-driven view that contains information about a service that is used in financial processes. The Material Inventory Process Control Template master data object 179 represents a template that simplifies the maintenance of material master data used to control several logistic processes. The collection includes the inventory management unit of measure and the unit of measure in which a material is serialized. The Service Product Procurement Process Control master data object 180 represents a process-driven view that contains information about a service that is used in procurement-relevant processes. The Material Procurement Process Control Template master data object 181 represents a template that simplifies the maintenance of material master data used in procurement-relevant processes. The Material Financials Process Control Template master data object 182 represents a template that simplifies the maintenance of material master data used to process in Financials (including the inventory valuation). The Service Product Procurement Process Control Template master data object 183 represents a template that simplifies the maintenance of Service Product master data used in procurement-relevant processes. The Warranty master data object 184 represents a guarantee to vouch for defects or faults in the product purchased that is valid for a specific period of time. The type and scope of the services covered, such as repairing a defect for free or taking the product back, are defined in the warranty. The Individual Material Service Process Control master data object 185 represents a process-driven view that contains information about an individual material in customer service processes. The Material Sales Process Control Template master data object 186 represents a template that simplifies the maintenance of material master data used to control presales, sales, and customer service processes. The Individual Material master data object 187 represents a tangible product that occurs only once in the real world and is therefore uniquely identifiable. The Material Financials Process Control master data object 188 represents a process-driven view that contains information about a material that is used in financial processes. The Service Product Financials Process Control Template master data object 189 represents a template that simplifies that simplifies the maintenance of Service Product master data used in processes in Financials (including the inventory valuation). The Material Availability Confirmation Process Control master data object 190 represents a process-driven view that contains information about a material that is used in availability confirmation processes. The Warranty Service Process Control master data object 191 represents a process-driven view that contains information about a warranty that is used in customer service processes. The Material Sales Process Control master data object 192 represents a process-driven view that contains information about a material that is used in presales, sales, and customer service processes. The Service Product Template master data object 193 represents a template that contains service product data relevant for presales, sales, and financials processes. The Material Template master data object 194 represents a template that contains material data relevant for presales, sales, financials, supply planning, and availability confirmation processes. The Material master data object 195 represents a tangible product, such as a sellable article, packaging, auxiliary material, and expendable supplies, that can be created and then represents a business value. In general, a material can be traded, consumed, or produced. The Service Product Sales Process Control Template master data object 196 represents a template that simplifies the maintenance of service product master data used to control presales, sales, and customer service processes. The Material Availability Confirmation Process Control Template master data object 197 represents a template that simplifies the maintenance of material master data used to execute the availability check. The Service Product master data object 198 represents an intangible product that describes the provision of a service. A service is provided at the time of its use. The Service Product Sales Process Control master data object 199 represents a process-driven view that contains information about a service that used in presales, sales, and customer service processes. The Identified Stock master data object 101A represents a subset of a material that shares a set of common characteristics, is logistically handled separately from other subsets of the same material and is uniquely identified. The Material Inventory Process Control master data object 102A represents a process-driven view that contains information about a material that is used in logistics processes.

The Resource Data Management process component 104 (FIG. 1D) manages the master data used to define a resource. This data specifies the nature of the resource as well as the capacities and the services that can be provided by the resource. The Resource Data Management process component 104 includes: a Resource transformed object 103Ald, an Equipment Resource master data object 104A, a Vehicle Resource master data object 105A a Labor Resource master data object 106A, a Resource Group master data object 107A, and a Resource Operating Time Template master data object 108A. The Resource transformed object 103A represents an asset that contributes to the sourcing, production or delivery of a product. The Equipment Resource master data object 104A represents a machine, device, tool, or a group of identical machines, devices, or tools having the capacity to provide services. The Vehicle Resource master data object 105A represents a means of transportation or a group of identical means of transportation providing capacity to perform transportation services. The means of transportation are not necessarily directly assigned to the vehicle resource. That is, the capacity of a vehicle resource can be provided by several means of transportation either at the same time or alternatively. The Labor Resource master data object 106A represents an employee or a group of employees with the same skills and qualifications that provides capacity to operate specific devices or to perform specific tasks. The Resource Group master data object 107A represents a grouping of individual resources based on similar physical characteristics, identical functional characteristics, or because of their usage in the same business area. The Resource Operating Time Template master data object 108A represents a template of an operating time definition that contains information used to maintain the operating times for multiple resources.

The Location Data Management process component 105 (FIG. 1D) manages master data used for physical locations, the data including the location as well as objects that depend on the location or group locations. The Location Data Management process component 105 includes: a Location master data object 109A, a Transportation Zone master data object 110A, a Transportation Lane master data object 111A, and a Supply Planning Area master data object 112A. The Location master data object 109A represents a geographical place. The Transportation Zone master data object 110A represents a zone containing geographical locations that may be considered collectively for modeling or planning transportation routes or transportations. The Transportation Lane master data object 111A represents a relationship between two locations or transportation zones that specifies which materials can be transported between the locations or transportation zones, and which means of transport can be used. The Supply Planning Area master data object 112A represents groups of requirements, stocks and other requirements coverage elements with the purpose of being together taken into account in net requirements calculation of supply planning For example, the elements can provide a separate allocation of products and ensure the availability of products on time for a supply planning area. Requirements, stocks and other requirements coverage elements typically can be assigned to exactly one supply planning area. A systematic and specific supply planning for products within a supply planning area can be enabled. Every site can have a supply planning area. Introducing additional supply planning areas can help to separate requirements, stocks and other requirements coverage elements of one site.

The Logistics Area and Storage Management process component 106 (FIG. 1E) maintains logistics area master data and storage methods, as well as placement and retrieval rules for inventory. The Logistics Area and Storage Management process component 106 includes: a Logistics Area master data object 113A, a Logistics Source and Destination Determination Rule master data object 114A, a Storage Behavior Method master data object 115A, and a Storage Control master data object 116A. The Logistics Area technical object 113A represents a freely definable area within a location providing detailed physical and operational information used for storage and production. Logistics areas can be arranged in a hierarchy according to physical aspects or logistical functions. The Logistics Source and Destination Determination Rule master data object 114A represents a rule for identifying the source storage location for inventory retrieval or the destination storage location for inventory placement. The Storage Behavior Method master data object 115A represents a set of rules defining the manner in which a storage location is managed. The Storage Control master data object 116A a specification of inventory items' constraints and inventory items' rules applied in a storage location, such as logistics area or resource, as well as requirements for actions.

The Human Capital Master Data Management process component 107 (FIG. 1E) manages the work agreements, employments, and human capital master data used in different human capital master areas. The Human Capital Master Data Management process component 107 includes: a Work Agreement master data object 117A, an Employment master data object 118A, and a Compensation Component Type master data object 119A. The Work Agreement master data object 117A represents a contract between an employer and an employee by means of which the employee is obliged to provide his or her labor while the employer is obliged to provide the agreed compensation. The Employment master data object 118A represents a relationship which comes into being by virtue of one or more valid work agreements. For example, the work agreement can consist only of the specific labor-related arrangements agreed between company and employee; the employment can encompass the entire legal relationship between the contracting parties. The Compensation Component Type master data object 119A represents a description of the employee compensation components in the context of human resources.

The Business Document Flow Processing process component 108 (FIG. 1E) collects a sequence of documents related to a business transaction. The Business Document Flow Processing process component 108 includes a Business Document Flow transformed object 120A, and a Business Process Chain Assignment dependent object 121A. The Business Document Flow transformed object 120A represents a view on the flow of business transaction documents. Predecessor and successor documents for a given business document can be compiled and included. The Business Process Chain Assignment dependent object 121A represents an assignment of a business object node to a business process chain.

The Document Management process component 109 (FIG. 1E) manages documents related to business transactions. The Document Management process component 109 includes a Document master data object 122A and the Document Template technical object 123A. The Document master data object 122A represents a carrier of unstructured information and additional control and monitoring information. The Document Template technical object 12A represents a template, which defines the content, format, placeholders and the structure for creating new documents having a uniform style.

The Production Model Management process component 110 (FIG. 1F) maintains and releases master data used for production planning and production execution. The Production Model Management process component 110 includes: a Production Model master data object 124A, a Production Bill of Material master data object 125A, a Production Bill of Operations master data object 126A, a Released Planning Production Model master data object 127A, a Released Execution Production Model master data object 128A, and a Production Segment master data object 129A. The Production Model master data object 124A represents a model of a production process in a production center that is defined by a network of production segments. The Production Bill of Material master data object 125A represents a complete and structured list that defines and describes the components that are used in the production of a material or family of similar materials. The Production Bill of Operations master data object 126A represents a description of a production process for manufacturing a product. The description can include the processing or transformation steps that have to be executed. The description can also define the resources to be used with the necessary technical specifications such as the standard times, capacity requirements, and work instructions. The Released Planning Production Model master data object 127A represents a released version of a production model that contains all the production bill of operations and production bill of material data used for the planning of a production process. The Released Execution Production Model master data object 128A represents a released version of a production model that contains all the production bill of operations and production bill of material data used for the execution of a production process. The Production Segment master data object 129A represents part of a production process in a production center specified by a network of operations and assigned materials for the production of a material.

The Site Logistics Model Management process component 111 (FIG. 1F) maintains and releases master data used for site logistics execution. The Site Logistics Model Management process component 111 includes: a Site Logistics Bill of Operations master data object 130A, a Site Logistics Process Segment master data object 131A, a Site Logistics Process Model master data object 132A, and a Released Site Logistics Process Model master data object 133A. The Site Logistics Bill of Operations master data object 130A represents a detailed description of how a product is to be moved, packed and otherwise dealt with during site logistics processing. The site logistics bill of operations can consist of operations with attached execution instructions. The Site Logistics Process Segment master data object 131A represents a part of a logistics process specified by a set of operations for packing, moving and checking of goods. The Site Logistics Process Model master data object 132A represents a model of the site logistics process that is specified by a sequence of site logistics process segments. The Released Site Logistics Process Model master data object 133A represents a released version of a site logistics process model that contains all elements required for defining and describing the execution of a site logistics process.

The Activity Management process component 112 (FIG. 1G) records activities, such as business activities and tasks, undertaken on behalf of the company. The Activity Management process component 112 includes: an Activity Task business process object 134A, a Phone Call Activity business process object 135A, a Letter Activity business process object 136A, an Appointment Activity business process object 137A, an Email Activity business process object 138A, a Fax Activity business process object 139A, and an Activity transformed object 140A. The Activity Task business process object 134A represents information an employee needs to do within a certain time frame and can be related to a business partner. The Phone Call Activity business process object 135A represents an activity that records telephone interactions that are undertaken by employees on behalf of their company. The Letter Activity business process object 136A represents an activity that records a message written on paper by an employee of a company on the company's behalf. The Appointment Activity business process object 137A represents a planned or unplanned activity that is maintained in a calendar of an employee of a company. It can include external appointments and scheduled meetings with other business partners. An appointment can typically contain information regarding the business partner involved, the date on which it is to take place, and whether it is related to business or is private in nature. The Email Activity business process object 138A represents an activity that contains information communicated via the Internet or an internal groupware server. The information can include texts and attachments. The Fax Activity business process object 139A represents an activity that contains documents or graphics transmitted via a telecommunications facility by an employee of a company. The Activity transformed object 140A represents a structured view of activities of various types in order to plan and document all actions and interactions related to business partners.

The Source of Supply Determination process component 113 (FIG. 1G) maintains and provides access to sources of supply and quota arrangements for external and internal procurement processes. The Source of Supply Determination process component 113 includes a Supply Quota Arrangement master data object 141A, a Source of Supply master data object 142A, a Sourcing Allocation business process object 144A, and a Sourcing List transformed object 143A. The Supply Quota Arrangement master data object 141A represents a distribution of material requirements or issues to different sources of supply, business partners, or internal organizational units. The Source of Supply master data object 142A represents an object that describes a logical link between a possible source of products and a possible target. The Sourcing Allocation business process object 144A represents the allocation of a product quantity to a source of supply or a supply quota arrangement item that is to be procured or produced. The Sourcing List transformed object 143A represents a sorted list of procurement possibilities which can be used for a source of supply determination. The list can contain information regarding sources of supply, means of transport and supply quota arrangements.

The Software Problem Reporting process component 114 (FIG. 1G) is used for collecting context data in a centric information technology (IT) solution in case of an incident, summarizing these data in a software problem report, and sending the report to an appropriate service desk. An incident can be a term according to ITIL (IT Infrastructure Library) terminology, an international de-facto standard for IT service and application management. Software Problem Reporting functionality can be deployed on more than one decentralized system, and can forward the information to a central service desk. The Software Problem Reporting process component 114 includes a Software Problem Report technical object 145A. The Software Problem Report technical object 145A represents a report about an incident in a centric information technology solution. The report can be triggered, for example, either by an end-user or by the system itself. The report can document the information about the person, system, and context data of the incident.

The Installed Base Data Management process component 115 (FIG. 1G) manages and structures installed objects, such as personal computers or parts of a software installation, in an installed base, according to their logical or physical location. The Installed Base Data Management process component 115 includes an Installed Base master data object 146A and an Installation Point master data object 147A. The Installed Base master data object 146A represents a container that holds structured information of business components and their compositions, as well as their business features. Installed base components carry properties of business objects (e.g., materials or individual materials), which have been assigned to an installed base. The components can be multi-level structured, can be time dependent, and can contain descriptive information about their corresponding business component. An installed base component can include, for example, address and/or application specific extensions. The Installation Point master data object 147A represents a physical or logical location at which a business object, such as software or a material, is installed during a certain period of time. An installation point can contain descriptive information about its installed object, such as the quantity of materials used, and can be structured in a hierarchical relationship with other installation points.

The Price Master Data Management process component 116 (FIG. 1H) manages prices and price-related data for sales and procurement processes. The Price Master Data Management process component 116 includes: a Sales Price Specification master data object 148A, a Sales Price List master data object 149A, and a Procurement Price Specification master data object 150A. The Sales Price Specification master data object 148A represents the specification of a price, discount or surcharge used indirectly for pricing in sales and service documents. The Sales Price List master data object 149A represents a list of price specifications with respect to common identifying criteria. The Procurement Price Specification master data object 150A represents the specification of a price, a discount, or a surcharge for procurement of goods or services. The specification is defined for a combination of property values and is valid for a specific period.

The Identity Management process component 117 (FIG. 1H) identifies individuals in a system landscape and controls their access by associating user rights and restrictions. The Identity Management process component 117 includes: an Identity master data object 151A, an Access Group process control object 152A, and an Access Control List process control object 153A. The Identity master data object 151A represents a combination of all user accounts of a person in a system landscape and can include the settings used for system access and the associated user rights and restrictions. The Access Group process control object 152A represents a group of identities for which access control is specified in a certain context. The Access Control List process control object 153A represents a list of access groups that have access to the entire host object during a validity period.

The Data Flow Verification process component 118 (FIG. 1H) represents the act of verifying that the data flow between business objects has been carried out correctly. For example, the flow of data between business objects can be checked by examining the message exchange between sender and receiver, or by comparing the business object instances. The Data Flow Verification process component 118 includes: a Data Flow Verification Run mass data run object 154A and a Data Flow Verification Result business process object 155A. The Data Flow Verification Run mass data run object 154A represents the specification of an automated run to verify the data flow between business objects. The Data Flow Verification Result business process object 155A represents the result of the verification process of the data flow between business objects.

The Engineering Change Processing process component 119 (FIG. 1I) processes changes to master data used in the product lifecycle phases engineering and manufacturing, including the definition of validity parameters and the release of the changes. The Engineering Change Processing process component 119 includes an Engineering Change Order business process object 156A. The Engineering Change Order business process object 156A represents a set of instructions to make changes to a number of objects from the areas of engineering or production. An engineering change order can define the conditions under which these changes become effective and can specify the release status of these changes.

The Financial Market Data Management process component 120 (FIG. 1I) manages financial market data such as data obtained from generally accepted external providers. The Financial Market Data Management process component 120 includes a Bank Directory Entry master data object 157A. The Bank Directory Entry master data object 157A represents an entry with the main information on a bank in a classified directory of banks.

The Logistic Unit Data Management process component 121 incorporates all master data necessary when handling or using logistic units, including grouping and packing instructions. The Logistic Unit Data Management process component 121 includes a Logistic Unit master data object 158A, a Logistic Unit Usage master data object 159A, and a Packing Bill of Material master data object 160A. The Logistic Unit master data object 158A represents an item established for logistics operations, such as storage, movement, and packing. The Logistic Unit master data object 158A can represent all physical units handled in the same manner during logistic operations, whether they are packed or unpacked goods. The Logistic Unit Usage master data object 159A represents a logistics purpose for which Logistic Units are grouped. The Logistic Unit Usage can represent a process or an activity, such as conveying, packing, or storing. The Packing Bill of Material master data object 160A represents a complete and structured list of components that define the packing structure of logistic units.

The Input and Output Management process component 122 covers form-based input and output as well as structured file import and export. For example, form-based input and output can include collaboration by means of interactive forms. Output management can handle front-end and back-end output. Form-based output can have different channels such as print, e-mail and fax. The 122 Input and Output Management process component includes: a Controlled Output Request dependent object 161A, an Output Request technical object 162A, an Output Task technical object 163A, an Output Error technical object 164A, a File Input Control technical object 165A, an Output Control dependent object 166A, and an Output Determination Rule master data object 167A. The Controlled Output Request dependent object 161A represents a request to send documents related to the hosting business object to a specified output channel. It can support form-based back-end output of the hosting business object and stores the output history. The Output Request technical object 162A represents a request to send a document to a specified output channel. The Output Task technical object 163A represents a task that outputs data to an output channel. The Output Error technical object 164A represents an error that occurred during the processing of an output request. The File Input Control technical object 165A represents the initiation and control of the processing of inbound files by the adapter service. The Output Control dependent object 166A represents a set of settings for form-based output via channels like print, email and fax. It controls master-data dependent output. The Output Determination Rule master data object 167A represents a rule defining which set of output parameters to use during output. An Engineering Change Case business process object 168A is also included in the Foundation layer in FIG. 1L. The Engineering Change Case business process object 168A represents a collection of documents, references, and decisions used to identify a potential solution to problems that initiate an engineering change; to research, design, and validate engineering change alternatives; and to review and decide on the implementation of the change. It contains instructions for the participants in the change and defines their responsibilities.

As shown in FIG. 1J, the Foundation Layer 100 also includes: a Payment Explanation dependent object 169A, an Accounting Coding Block Distribution dependent object 146A, a Financial Audit Trail Documentation dependent object 170A, an Address dependent object 148A, a Storage Control dependent object 171A, a Payment Control dependent object 172A, a Market Segment dependent object 173A, a Cash Discount Terms dependent object 174A, an Attachment Folder dependent object 175A, a Text Collection dependent object 176A, a Product Requirement Specification business process object 155A, and an Identified Stock master data object 158A.

The Payment Explanation dependent object 169A represents the reason(s) for a payment, typically with reference to one or more business documents such as contracts, invoices, credit memos, or sales orders. The Accounting Coding Block Distribution dependent object 146A represents the distribution of coding blocks to enterprise resources changes, such as expenses or material movements. A coding block can be a set of accounting objects to which an enterprise resource change is assigned. The resource change can ultimately be valued in Accounting. For example, an employee can record eight hours of his working time (the resource change), allocated six hours to a project and two hours to his cost center, thereby distributing his total time to two coding blocks (the first containing the project, and the second containing the cost center). The Financial Audit Trail Documentation dependent object 170A represents the uniform documentation of the changes to receivables and payables and financial transactions linked to a business transaction for audit purposes. The Address dependent object 148A represents the data that describes the addressee, postal address and communication connections. The address can be used both in master data objects (e.g., customer) and business process objects (e.g., sales order). The Storage Control dependent object 171A represents the specification of inventory items' constraints and inventory items' rules applied in a storage location (such as logistics area or resource), as well as requirements for actions (such as replenishment and cleanup). The Payment Control dependent object 172A represents an agreement between a company and a business partner on processing payments for an individual business transaction. The Market Segment dependent object 173A represents a sector of the overall market that is characterized by a specific constellation of supply and demand and that exhibits specific customer and product characteristics as well as characteristics for regional and organizational classification (e.g., sweets that are sold within the region Europe). The Cash Discount Terms dependent object 174A represents the modalities agreed upon between business partners for the payment of goods delivered or services provided. These modalities can consist of incremental payment periods and the cash discounts that are allowed when payment is made within one of these periods. Cash discount terms can be used to define terms of payment, for example, for a purchase order or invoice issue for control the common transactional buffer for Folder dependent object 175A represents a collection of planning data. The Go Live Checklist transformed object 166A represents a check list which guides the customer through the activities which are mandatory or critical before going live with the customer's system landscape. During business setup or during continuous change, the customer can typically perform several activities in order to adjust the system to specific business needs.

As shown in FIG. 1K, the Foundation Layer 100 also includes: a Cross Product Catalog Search technical object 177A, a Transactional Planning Data Buffer Control technical object 178A, a Process Integration Inbound Error technical object 179A, a Task technical object 180A, a Catalog Access Result technical object 181A, and a Catalog Access Specification technical object 182A

The Cross Product Catalog Search technical object 177A represents the condition used for and the result of a search across product catalogs. The Transactional Planning Data Buffer Control technical object 178A represents a means to control the common transactional buffer for planning data. The Process Integration Inbound Error technical object 179A represents an error that occurred during the inbound message processing. It contains information about the incorrectly exchanged message like the message payload and log messages of the inbound processing. The Task technical object 180A represents a task is a request to perform an action that can be executed in order to achieve a business or technical objective. The task results from changes within a business or technical process. The Catalog Access Result technical object 181A represents a result from a catalog that contains user-requested data, which is transferred from a catalog to a business document. The Catalog Access Specification technical object 182A represents a specification to access a web-based catalog that contains a uniform identifier including parameters and control settings.

As shown in FIG. 1L, the Foundation Layer 100 also includes: a Currency Conversion reuse service component 183A and a Quantity Conversion reuse service component 184A. The Currency Conversion reuse service component 183A offers a service that converts currency amounts in different currencies. The Quantity Convention reuse service component 184A offers services for conversion, calculation and comparison of quantities and measures.

As shown in FIG. 1M, the Foundation Layer 100 also includes the Payment Master Data Management process component 123 and the Pricing Engine process component 124. The Payment Master Data Management process component 123 handles the management of payment master data, such as clearing house accounts, that is used in different business areas. It also contains views of house bank accounts and cash storages. The Payment Master Data Management process component 123 includes a Clearing House Account master data object 185A, a Core View of House Bank Account master data object 186A, and a Core View of Cash Storage master data object 187A. The Clearing House Account master data object 185A represents a company-internal representation of an account that is set up and managed at a clearing house for card payments for the company. It is based on an agreement between the company and the clearing house. The Core View of House Bank Account master data object 186A represents a view of a house bank account that contains identification, type, and currency data. The Core View of Cash Storage master data object 187A represents cash storage availability.

The Pricing Engine process component 124 handles the processing of price and tax calculation. The Pricing Engine process component 124 includes a Price and Tax Calculation dependent object 188A, a Price Calculation dependent object 189A, a Tax Calculation dependent object 190A, and a Price Specification dependent object 191A. The Price and Tax Calculation represents the summary of the determined price and tax components for a business case. The Price Calculation dependent object 189A represents the summary of the determined price components for a business case. The Tax Calculation dependent object 190A represents the summarization of the determined and calculated tax elements of a business case. The Price Specification dependent object 191A represents a specification of a price, a discount, or a surcharge for sales, service, and purchasing. The specification is defined for a combination of properties and is valid for a specific period.

As shown in FIG. 1N, the Foundation Layer 100 also includes the Property Management process component 125 and a Product Property Management process component 126. The Property Management process component 125 handles the management of properties along with their valuations. The Property Management process component 125 includes a Property Type System Value Help dependent object 192A, a Property Valuation List dependent object 193A, a Property Type System View dependent object 194A, and a Property Type System dependent object 195A. The Property Type System Value Help dependent object 192A represents a value-help enabler for nodes of the Property Type System dependent object. The Property Valuation List dependent object 193A represents a list of instance- or group-specific properties (qualities) of an object, along with their valuations. The Property Type System View dependent object 194A represents a view that provides both aggregated and detailed information about property type systems. The Property Type System dependent object 195A represents a consistent system of object properties, along with their definitions and underlying property data types.

The Product Property Management process component 126 handles the management of product properties along with their valuations. The Product Property Management process component 126 includes a Product Property List master data object 196A, Product Property Valuation List dependent object 197A, a Product Category Hierarchy master data object 198A, a Product Property Library master data object 199A, and a Product Property Type System dependent object 101B. The Product Property List master data object 196A represents a list of properties from product property libraries that are adjusted to suit one or more products. Attributes of the properties can be added or changed in the list. The Product Property Valuation List dependent object 197A represents a list of product properties of an object with their valuations. The properties and valuations are based on a product property list or product property library. The Product Category Hierarchy master data object 198A represents a hierarchical arrangement of product categories according to objective business aspects. Subordinate product categories represent a semantic refinement of the respective higher-level product category. The Product Property Library master data object 199A represents a library of product properties that can be reused to further describe instances or groups of business objects in specific application areas. The Product Property Type System dependent object 101B represents a consistent system of product properties, along with their definitions and underlying property data types.

As shown in FIG. 1O, the Foundation Layer 100 also includes the Application Log Administration process component 134, the Change Document Management process component 135, the Inspection Master Data Management process component 136, the Product Engineering Foundation process component 137, the Records and Case Management 138, and the Key Performance Indicator Management process component 139.

The Application Log Administration process component 134 handles the administration of application logs. The Application Log Administration process component 134 includes an Application Log technical object 102B that represents a collection of textual information automatically created by the application that describes the activities of a business object. This also includes relevant information about the environment and references to the business object nodes that are involved in the creation of the information.

The Change Document Management process component 135 handles the management of changed documents. The Change Document Management process component 135 includes the Change Document business process object 103B that represents a record of changes made to a object instance. It specifies the identity of the user responsible for the change and the change date and time.

The Inspection Master Data Management process component 136 handles the management of inspection-relevant master data, such as inspection rules and sample-drawing procedures, as well as the definition of quality-relevant catalogs. The Inspection Master Data Management process component 136 includes a Quality Issue Category Catalog 104B, a Sample Drawing Procedure 105B, and an Inspection Rule master data object 106B. The Quality Issue Category Catalog master data object 104B represents a structured catalog of categories that classifies quality-related issues for a particular quality aspect. The Sample Drawing Procedure master data object 105B represents a procedure that defines how samples are to be taken. It contains data for the sample-drawing frequency, sample size, and sample quantity. The Inspection Rule master data object 106B represents a rule that contains the specifications for an inspection. The inspection is used to check whether an object or procedure meets predefined requirements.

The Records and Case Management 138 handles the structuring of business folders. The Records and Case Management 138, includes a Business Folder dependent object 107B and a Business Folder Structure Definition master data object 108B. The Business Folder dependent object 107B represents a folder for collecting and organizing information relating to a business subject according to customer needs. The Business Folder Structure Definition master data object 108B represents a definition of the internal structure and constraints of business folders.

The Product Engineering Foundation process component 137 handles the engineering of product designs. The Product Engineering Foundation process component 137 includes the Product Design business object 109B.

The Key Performance Indicator Management process component 139 handles the management of key performance indicators of a company along with their evaluations. It comprises the services to identify, define, and evaluate key performance indicators of a company for management purposes. The Key Performance Indicator Management process component 139 includes a Key Performance Indicator Evaluation business process object 110B and a Key Performance Indicator business process object 111B.

The Key Performance Indicator Evaluation business process object 110B represents a user-specific, time-dependent, and parameter-based evaluation of a key performance indicator that results in a value. The key performance indicator value is usually assessed against a reference value based on a rule. The Key Performance Indicator business process object 111B represents a quantifiable business performance factor.

As shown in FIG. 1P, the Foundation Layer 100 also includes the Business Rules Management process component 127, the Accounting Coding Block Distribution Processing process component 128, the Business process component 129, the Number Range process component 130, the Data and Time process component 131, the Payment Authorization process component 132, and the Logistics Shift process component 133.

The Business Rules Management process component 127 includes the Business Rule Definition technical object 112B, the Business Rule Expression technical object 113B, and the Business Rule Parameter Definition technical object 114B. The Business Rule Definition technical object 112B represents a business rule comprising the name and the signature. It describes the operations, definitions, and constraints that apply to an organization in achieving its goals. The Business Rule Expression technical object 113B represents an expression that specifies the business logic of a business rule in a formal way. Business Rule Expressions may be simple such as a constant, case or range or complex such as a decision tree, a decision table or formula. Business Rule Expressions may be nested. The Business Rule Parameter Definition technical object 114B represents the definition of a formal parameter that can be used as an input or output parameter in one or more business rule definitions and in one or more business rule expressions.

The Accounting Coding Block Distribution Processing process component 128 includes an Accounting Coding Block Distribution dependent object that represents the Distribution of Coding Blocks to enterprise resources changes, such as expenses or material movements. A Coding Block is a set of accounting objects to which an enterprise resource change is assigned. The resource change is ultimately valued in Accounting.

The Business process component 129 includes a Go Live Checklist transformed object 116B that represents a list of business options for a business system's customer/prospect to check or further maintain in order to adjust the business system to their specific business needs. Until all activities in Go Live checklist are closed, the customer/prospect's business system can not go live. Each business option in Go Live Checklist is a group of predefined content sets or a manual activity which describes what needs to be done by documentation. The Go Live Checklist transformed object 116B offers the capability for system's customer/prospect to check and further maintain these content sets.

The Number Range process component 130 includes a Number Range technical object 117B that represents a range of numbers that are delimited by an upper and lower boundary, and generated in a consecutive order.

The Date and Time process component 131 includes an Operating Hours dependent object 118B that represents a generic description of time periods based on a recurrence pattern, during which operations are performed.

The Payment Authorization process component 132 includes a Payment Card Payment Authorization technical object 119B that represents an authorization for a payment made using a payment card. It contains payment information including a description of the goods/services purchased, the authorization request, and the result of the authorization request based on the response from the clearing house.

The Logistics Shift process component 133 includes a Logistics Break Program master data object 120B that represents a set of breaks in supply chain processes such as production, warehousing and transportation that are either scheduled at an absolute time of the day or scheduled relative to the start time of a shift; a Logistic Shift master data object 121B that represents a period of working time (called shift) in supply chain processes such as production, warehousing, and transportation that can be interrupted by break; and a Logistics Shift Program master data object 122B that represents a set of shifts, organized as a generic program, in supply chain processes such as production, warehousing and transportation that span over a period of time.

As shown in FIG. 1Q, the Foundation Layer 100 also includes an Address Data Management process component 140. The Address Data Management process component 140 includes a Used Address technical object 123B that represents an address that is currently being used by a business object node that can have multiple references for its address; an Organization Address dependent object 124B that represents an address of an organization, a group, or a similar entity; an Address dependent object 125B that represents data that describes the addressee, postal address, and communication data; a Workplace Address dependent object 126B that represents an address of a person's workplace within an organization; a Personal Address dependent object 127B that represents an address of a person; a Communication Data dependent object 128B that represents a set of communication data that does not include a postal address; and a Partner Address dependent object 129B that represents an address of an organization or a group, or the address of a person.

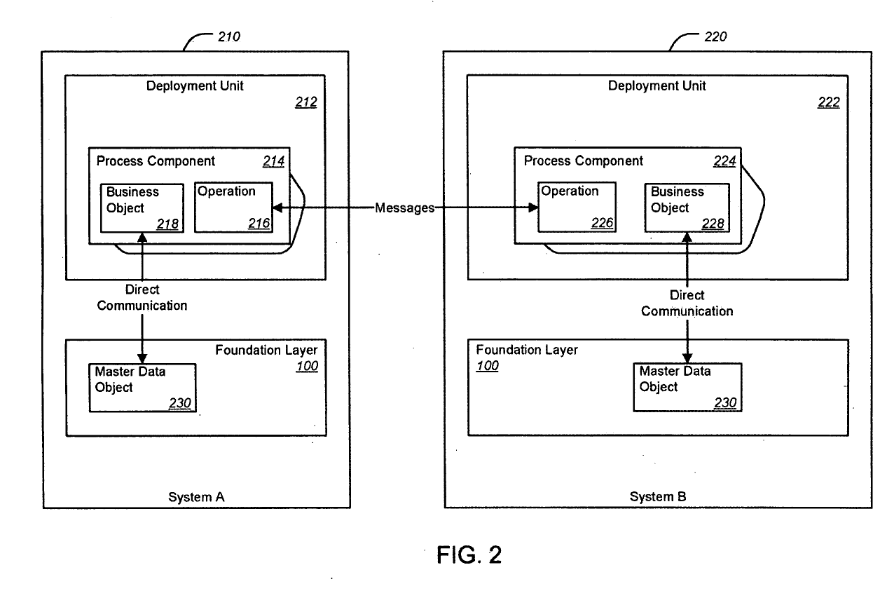

As shown in FIG. 2, the Foundation Layer 100 can be deployed on multiple separate and distinct hardware platforms, e.g., System A 210 and System B 220, to support application software deployed as two or more deployment units distributed on the platforms, including deployment unit 212 deployed on System A and deployment unit 222 deployed on System B. As explained above, process components in separate deployment units interact through service operations, as illustrated by messages passing between service operations 216 and 226, which are implemented in process components 214 and 224, respectively, which are included in deployment units 212 and 222, respectively. As also explained above, some form of direct communication is generally the form of interaction used between a business object, e.g., business object 218 and 228, of an application deployment unit and a business object, e.g., master data object 230, of the Foundation Layer 100.

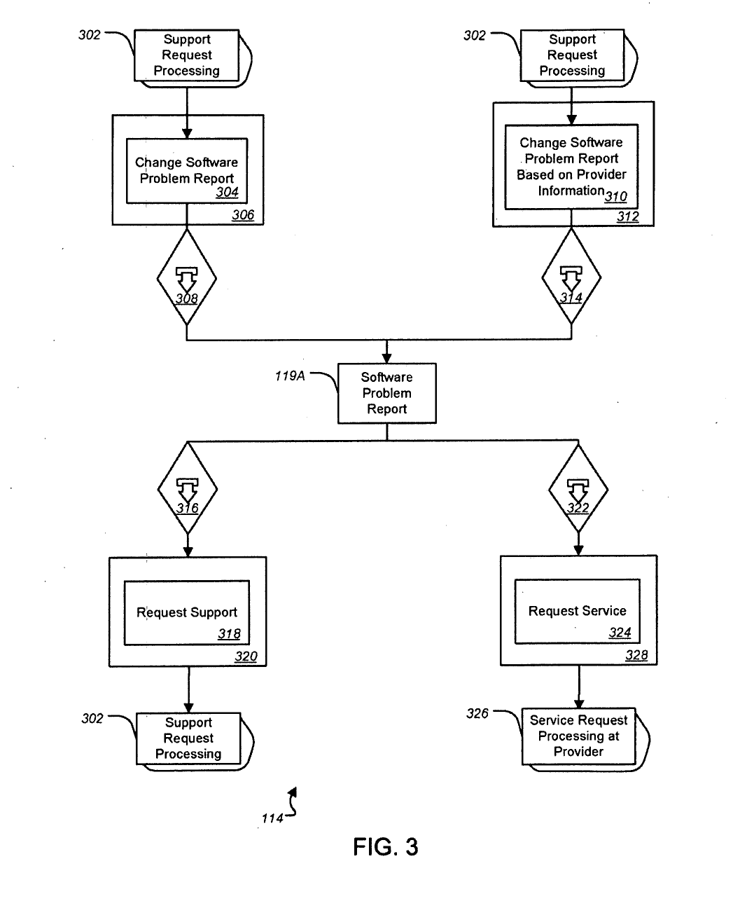

FIG. 3 is a block diagram of the Software Problem Reporting process component 114. The Support Request Processing process component 302 is shown in the figures for convenience in describing the process component 114. The process component 302 is not part of the process component being described. The Support Request Processing process component 302 is a request reflecting the initial inquiry to clarify and solve an incident during the operations of an IT system, sent by a user to an internal IT service desk. The support request documents the incident, the solution process and the solutions found. The process component 302 is used to represent software external to the process component in describing its interactions with the external software; however, while the external software can be implemented as such process component, this is not required.

An interaction may begin when a software problem report is to be changed. The Support Request Processing process component 302 can send a request for changing a software problem report, based on a confirmation coming from a service desk, to the Software Problem Reporting process component 114. The request is received as a message by a Change Software Problem Report operation 304. The operation 304 is included in a Software Problem Reporting In interface 306. The operation 304 initiates a Change Software Problem Report based on Confirmation asynchronous outbound process agent 308 to create or update the Software Problem Report technical object 145A.

The Support Request Processing process component 302 can send a request for changing a software problem report, based on provider information coming from a service desk, to the Software Problem Reporting process component 114. The request is received as a message by a Change Software Problem Report Based on Provider operation 310. The operation 310 is included in an External Requesting In interface 312. The operation 310 initiates a Change Software Problem Report based on Provider Information asynchronous outbound process agent 314 to create or update the Software Problem Report technical object 145A.

An update in the Software Problem Report technical object 145A calls a Request Support from Software Problem Report to Support Request Processing asynchronous outbound process agent 316 to invoke a Request Support operation 318. The operation 318 requests a creation or modification of a support request document in a service desk. For example, such a request can be sent to the Support Request Processing process component 302. The operation 318 is included in a Software Problem Reporting Out interface 320.

An update in the Software Problem Report technical object 145A calls a Request Service from Software Problem Report to Service Request Processing asynchronous outbound process agent 322 to invoke a Request Service operation 324. The operation 324 requests a creation or modification of a service request document in a service desk. For example, such a request can be sent to a Service Request Processing at Provider component 326. The Service Request Processing at Provider component may include logging and resolving of service requests concerning issues that customers have, for example, with regard to products. The operation 324 is included in a External Requesting Out interface 328.

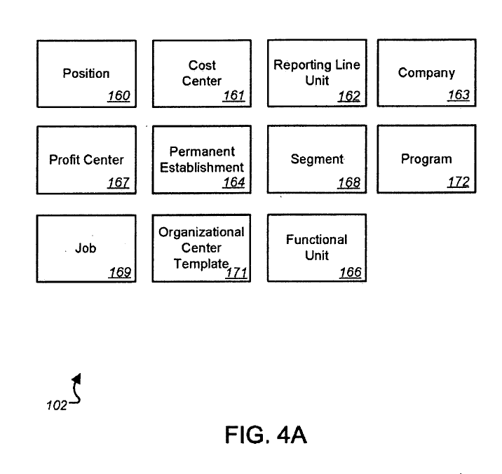

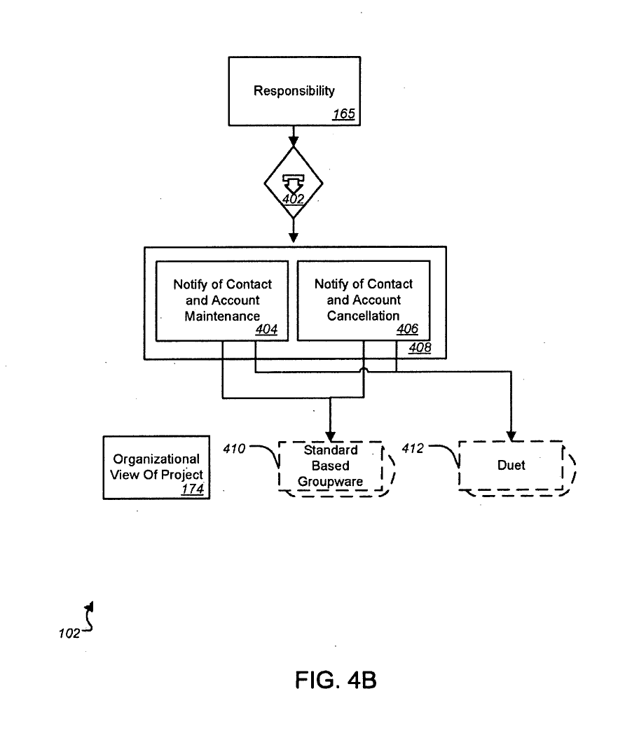

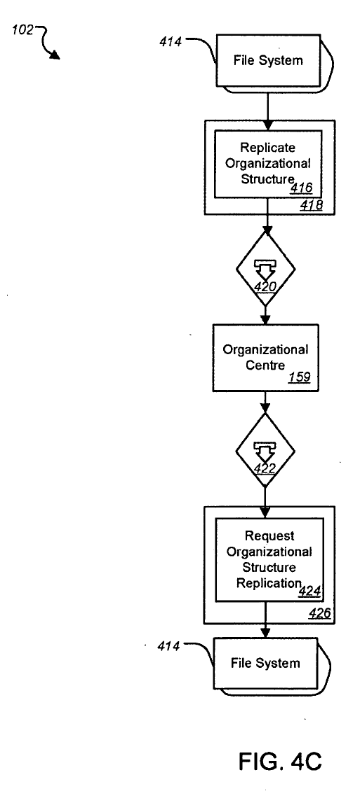

FIGS. 4A-4C are block diagrams showing an organizational management process component. As shown in FIG. 4A, the Organizational Management process component 102 provides central and unified organizational structures of the enterprise and its collaborative partners. The Organizational Management process component 102 includes a Position master data object 160, a Cost Center master data object 161, a Reporting Line Unit master data object 162, a Company master data object 163, a Permanent Establishment master data object 164, a Functional Unit master data object 166, a Profit Center master data object 167, a Segment master data object 168, a Job master data object 169, an Organizational Center Template master data object 171, and a Program master data object 172. The Position master data object 160 represents an organizational element within the organizational plan of an enterprise, and can permanently combines tasks, competencies and responsibilities that can be taken care of by one or more suitable employees. The Cost Center master data object 161 represents an organizational unit that represents a defined location of cost incurrence and for which costs are recorded separately. The Reporting Line Unit master data object 162 represents the organizational unit in the personnel reporting line of the enterprise. The reporting line unit can typically have a personnel manager who is responsible for defining the objectives and salaries of the directly or indirectly assigned holders. The Company master data object 163 represents a financially and legally independent, locally unbound entity registered under business law. The Permanent Establishment master data object 164 represents an organizational unit that represents a localized subdivision of a company whose business activities are subject to uniform fiscal treatment. The Functional Unit master data object 166 represents an organizational center responsible for the planning, execution and administration of business process steps. The responsibility can be performed by the organizational center itself, or it can be delegated. The Profit Center master data object 167 represents an organizational unit that represents a company area for which a separate period-based result for profit-oriented rating is determined. The Segment master data object 168 represents a business branch of a company for which a closing statement (e.g., a financial statement and a profit and loss statement) is to be created based on the segment reporting regulations within the context of the particular accounting principle (e.g., IAS, US-GAAP, or HGB). The Job master data object 169 represents the type of a position, such as task description, task profile, competencies, responsibilities, required qualifications and skill profiles. The Organizational Center Template master data object 171 represents a business unit in an organizational structure of a company within the extended enterprise. The Program master data object 172 represents an organizational center for managing a group of subprograms and projects. A program represents a complex, time-restricted set of activities for achieving high-level goals in the context of an extensive company strategy.

As shown in FIG. 4B, the Responsibility business object 165 uses a Notify of Responsibility to Groupware outbound process agent 402 to invoke either a Notify of Contract and Account Maintenance operation 404 or a Notify of Contact and account Cancellation operation 406. The operations 404 and 406 are included in a Contact Notification Out interface 408. The operations 404 and 406 can update an external Standards Based Groupware process component 410 or an external Duet process component 412. In some implementations, a change in the Organization View of Project business object 174 can invoke the interaction in FIG. 4B.

As shown in FIG. 4C, a File System process component 414 invokes a Replication Organizational Structure operation 416. The operation 416 is included in an Organizational Structure Replication In interface 418. The operation 416 uses a Replication Organizational outbound process agent 420 to update the Organizational Center business object 159. The Organizational Center business object 159 uses a Replication Organizational inbound process agent 422 to invoke a Request Organizational Structure Replication operation 424. The operation 424 is included in an Organizational Structure Replication Requesting Out interface 426. The operation 424 provides an update to the File System process component 414.

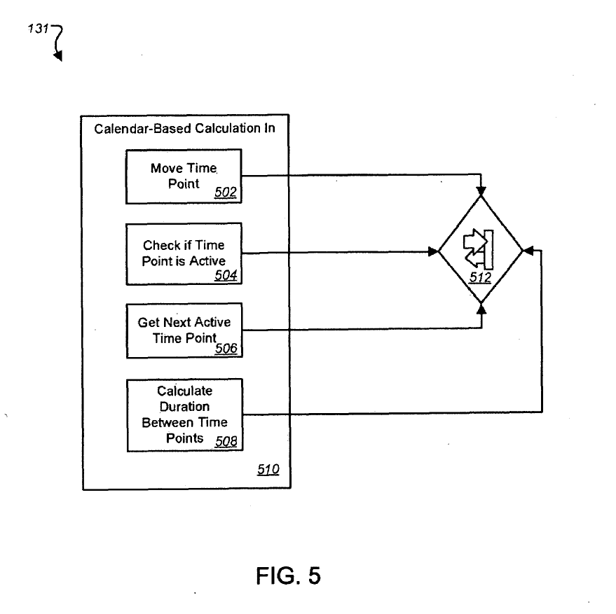

FIG. 5 is a block diagram showing an interaction in a date and time process component 131. The Date and Time process component 131 is a reusable service that handles the conversion, calculation, and comparison of time points, durations, and time periods. This component facilitates the handling of date and time information in a unified manner, configuration of date rules, and handling of working shifts, breaks, and operating hours.

An interaction can begin with an update to the Operating Hours business object 118B (not shown). The update may invoke a Move Time Point operation 502, a Check if Time Point is Active operation 504, a Get Next Time Active Time Point operation 506, or a Calculation Duration Between Time Points operation 508. The operations 502-508 are included in a Calendar-Based Calculation In interface 510. If one or more of the operations 502-508 are invoked, a Calendar-Based Calculation synchronous inbound process agent 512 can be used to update a business object or process component.

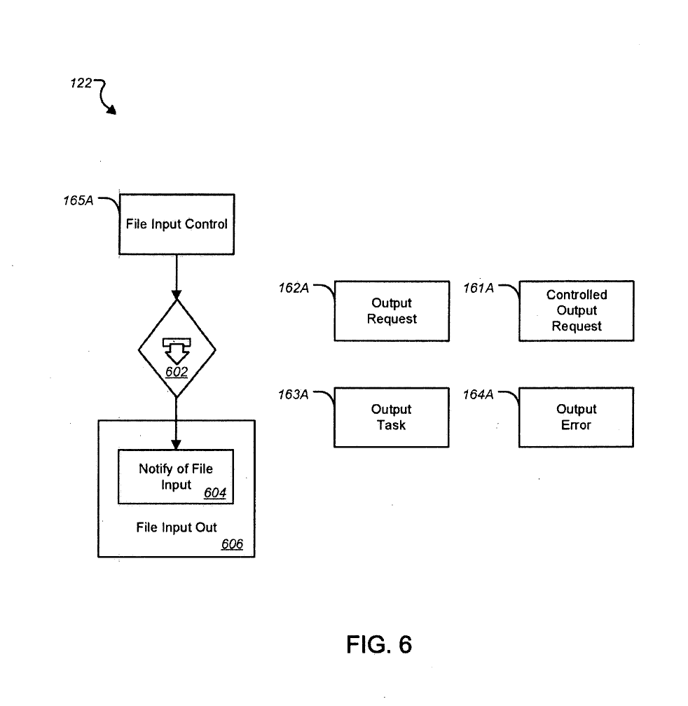

FIG. 6 is a block diagram of the Input and Output Management process component 122. The Input and Output Management process component 122 handles the form-based input and output as well as structured file import and export. The Input and Output Management process component 122 includes the Controlled Output Request business object 161A, the Output Request business object 162A, the Output Task business object 163A, the Output Error business object 164A, and the File Input Control business object 165A

An update in the File Input Control business object 165A calls a Notify of File Input to Adapter Service Outbound process agent 602 to invoke a Notify of File Input operation 604. The operation 604 notifies Input and Output Management about a file, which has to be processed. For example, such an update can be sent to the Input and Output Management process component 122. The operation 604 is included in a File Input Out interface 606.

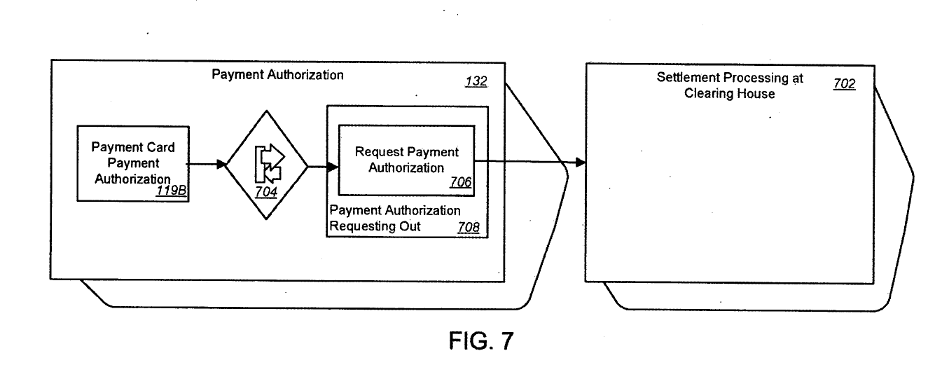

FIG. 7 is a block diagram showing an interaction with a Payment Authorization process component 132. The Payment Authorization process component 132 is a reusable service that is used to process the authorization request for a payment made using a payment card, at the clearing house. For example, component 132 can authorize the payment for goods or services purchased from an online store using a credit card. The Payment Authorization process component 132 can send an update to an external Settlement Processing at Clearing House process component 702. The Payment Authorization process component 132 includes the Payment Card Payment Authorization business object 119B.

An update in the Payment Card Payment Authorization business object 119B calls a Payment Authorization synchronous inbound process agent 704 to invoke a Request Payment Authorization operation 706. The operation 706 requests a clearing house for authorization of a payment made by a payment card. For example, the operation 706 may request a clearing house for authorization to the external Settlement Processing at Clearing House process component 702. The Request Payment Authorization operation 706 is included in a Payment Authorizing Requesting Out interface 708.

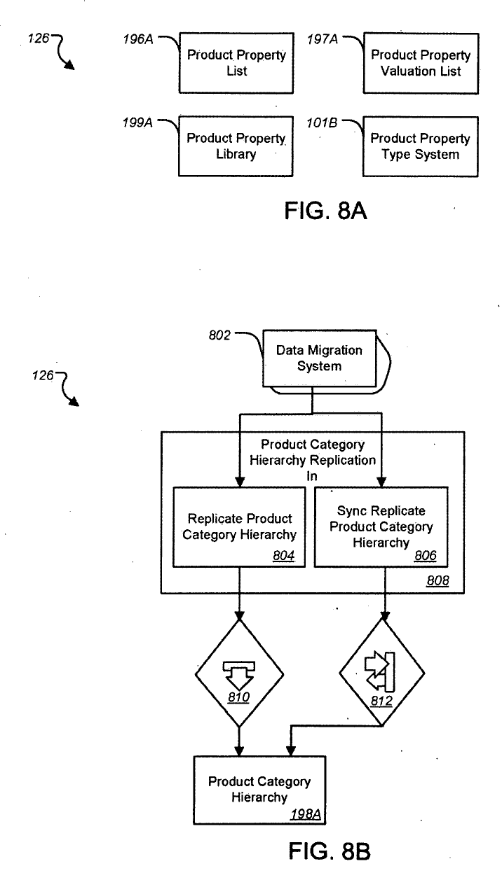

FIGS. 8A-B are block diagrams showing a product property management process component 126. A Data Migration System process component 802 is shown in the figures for convenience in describing the process component 126. The process component 802 is not part of the process component being described. The Data Migration System process component 802 is a request reflecting the initial inquiry to clarify and solve an incident during the operations of a system, sent by a user to an internal service desk. The support request documents the incident, the solution process and the solutions found. The process component 802 is used to represent software external to the process component in describing its interactions with the external software; however, while the external software can be implemented as such process component, this is not required.

The product property management process component 126 handles the management of product properties along with their valuations. FIG. 8A includes the Product Property business object 196A, the Product Property Valuation List business object 197A, the Product Property Library business object 199A, and the Product Property Type System business object 101B.

As shown in FIG. 8B, an update to any or all of the above business objects in FIG. 8A (e.g., 196A, 197A, 199A, or 101B) causes a Data Migration System process component 802 to invoke a Replicate Product Category Hierarchy operation 804 or a Synchronous Replicate Product Category Hierarchy operation 806. The Replicate Product Category Hierarchy operation 804 can create, update, or delete product category hierarchy master data in a target system, using product category hierarchy master data from a source system or file. The Synchronous Replicate Product Category Hierarchy operation 806 can create, update, or delete product category hierarchy master data in a target system, using product category hierarchy master data from a source file. The operations 804 and 806 are included in a Product Category Hierarchy Replication In interface 808.

If the Replicate Product Category Hierarchy operation 804 is invoked, a Replicate Product Category Hierarchy inbound process agent 810 can provide an update to the Product Category Hierarchy business object 198A. If the Synchronous Replicate Product Category Hierarchy operation 806 is invoked, a synchronous Replicate Product Category Hierarchy inbound process agent 812 can provide an update to the Product Category Hierarchy business object 198A.

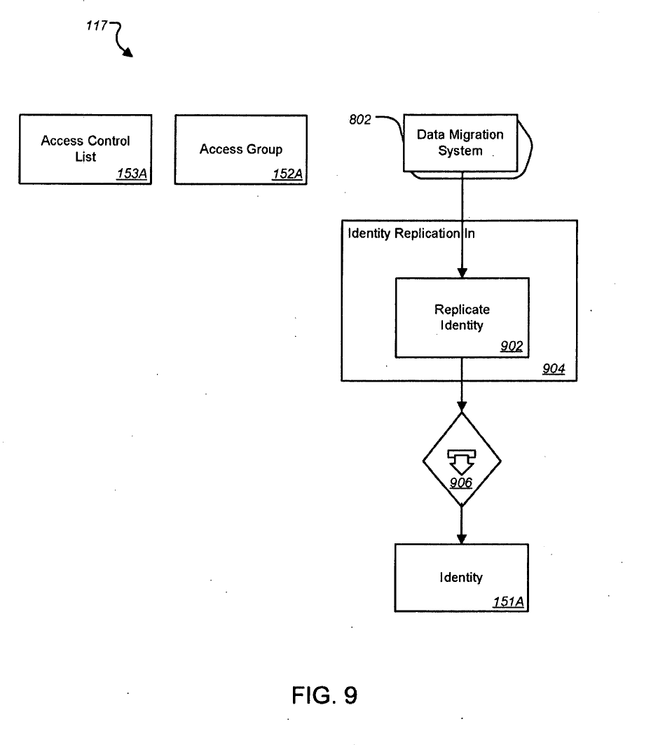

FIG. 9 is a block diagram showing an identity management process component 117. The identity management process component 117 handles the identification of individuals in a system landscape and controlling their access by associating user rights and restrictions. The identity management process component 117 includes the Access Control List business object 153A and the Access Group business object 152A. An update to either business object 152A or 153A invokes the Data Migration System process component 802 to invoke a Replicate Identity operation 902. The operation 902 can access identity information about a particular group individual or group. The Replicate Identity operation 902 is included in an Identity Replication In interface 904. The operation 902 can use a Replicate Identity Inbound process agent 906 to provide an update to the Identity business object 151A.

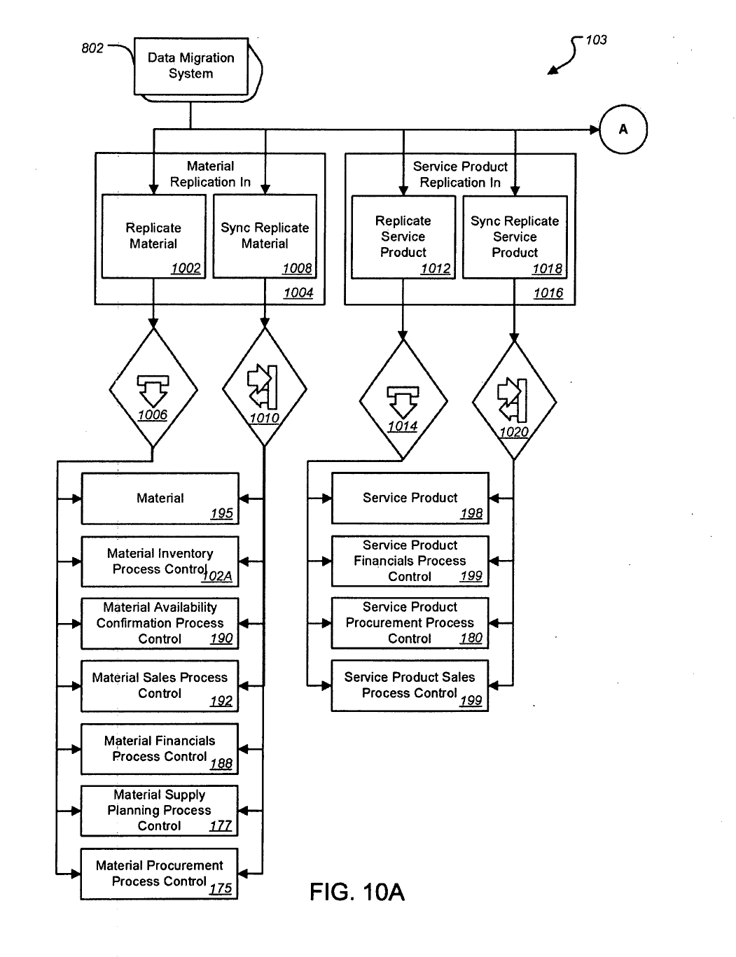

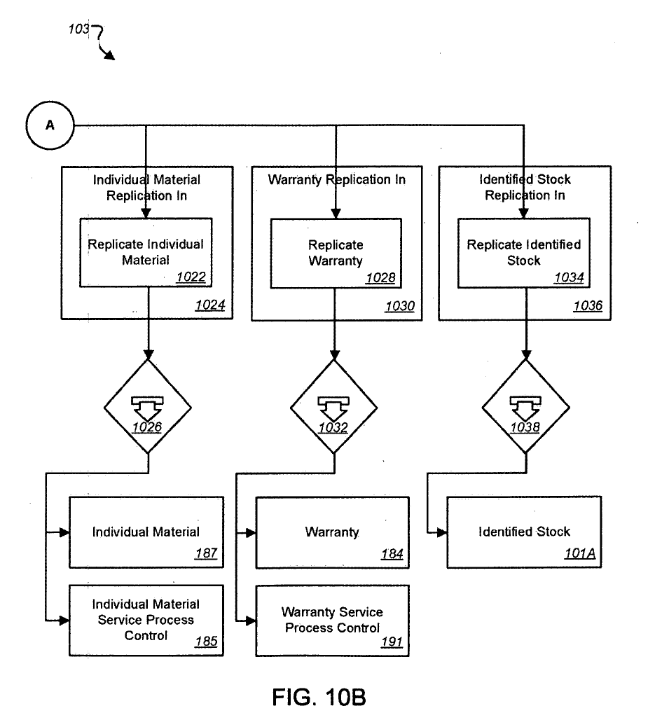

FIGS. 10A-B are block diagrams showing a product data maintenance process component 103. The product data maintenance process component 103 handles the maintenance of all product data that describes a company's tangible and intangible products, and that is used to control business processes such as sales, purchasing, planning, production, and accounting.

The interactions can be invoked by an update to an update in a Data Migration System process component 802. The Data Migration System process component 802 can invoke a Replicate Material operation 1002. The Replicate Material operation 1002 creates or updates material master data in a target system using material master data form a source system or file. The operation 1002 is included in a Material Replication In interface. The operation 1002 uses a Replicate Material inbound process agent 1006 to update the Material business object 195, the Material Inventory Process Control business object 102A, the Material Availability Confirmation Process Control business object 190, the Material Sales Process Control business object 192, the Material Financials Process Control business object 188, the Material Supply Planning Process Control business object 177, or the Material Procurement Process Control business object 175.

The Data Migration System process component 802 can also invoke a synchronous Replicate Material operation 1008 in the Material Replication In interface 1004. The synchronous Replicate Material operation 1008 uses a Replicate Material synchronous inbound process agent 1010 to update the Material business object 195, the Material Inventory Process Control business object 102A, the Material Availability Confirmation Process Control business object 190, the Material Sales Process Control business object 192, the Material Financials Process Control business object 188, the Material Supply Planning Process Control business object 177, or the Material Procurement Process Control business object 175.

The Data Migration System process component 802 can also invoke a Replicate Service Product operation 1012. The operation 1012 provides a process agent that migrates or replicates service product master data from a source system or file to a target system. The operation 1012 is included in a Service Product Replication In interface 1014. The Replicate Service Product operation 1012 uses a Replicate Service Product inbound process agent 1016 to update the Service Product business object 198, the Service Product Financials Process Control business object 199, the Service Product Procurement Process Control business object 180, or the Service Product Sales Process Control business object 199.

The Data Migration System process component 802 can also invoke a synchronous Replicate Service Product operation 1018. The operation 1018 uses a process agent that migrates or replicates service product master data from a source system or file to a target system. The operation 1018 is included in the Service Product Replication In interface 1014. The synchronous Replicate Service Product operation 1018 uses a Replicate Service Product synchronous inbound process agent 1020 to update the Service Product business object 198, the Service Product Financials Process Control business object 199, the Service Product Procurement Process Control business object 180, or the Service Product Sales Process Control business object 199.

As shown in FIG. 10B, the Data Migration System process component 802 can also invoke a Replicate Individual Material operation 1022 included in an Individual Material Replication In interface 1024. The operation 1022 uses a Replicate Individual Material inbound process agent 1026 to update the Individual Material business object 187 or the Individual Material Service Process Control business object 185.

The Data Migration System process component 802 can also invoke a Replicate Warranty operation 1028 included in a Warranty Replication In interface 1030. The operation 1028 uses a Replicate Warranty inbound process agent 1032 to update the Warranty business object 184 or the Warranty Service Process Control business object 191.

The Data Migration System process component 802 can also invoke a Replicate Identified Stock operation 1034 included in an Identified Stock Replication In interface 1036. The operation 1034 uses a Replicate Identity inbound process agent 1038 to update the Identified Stock business object 101A.

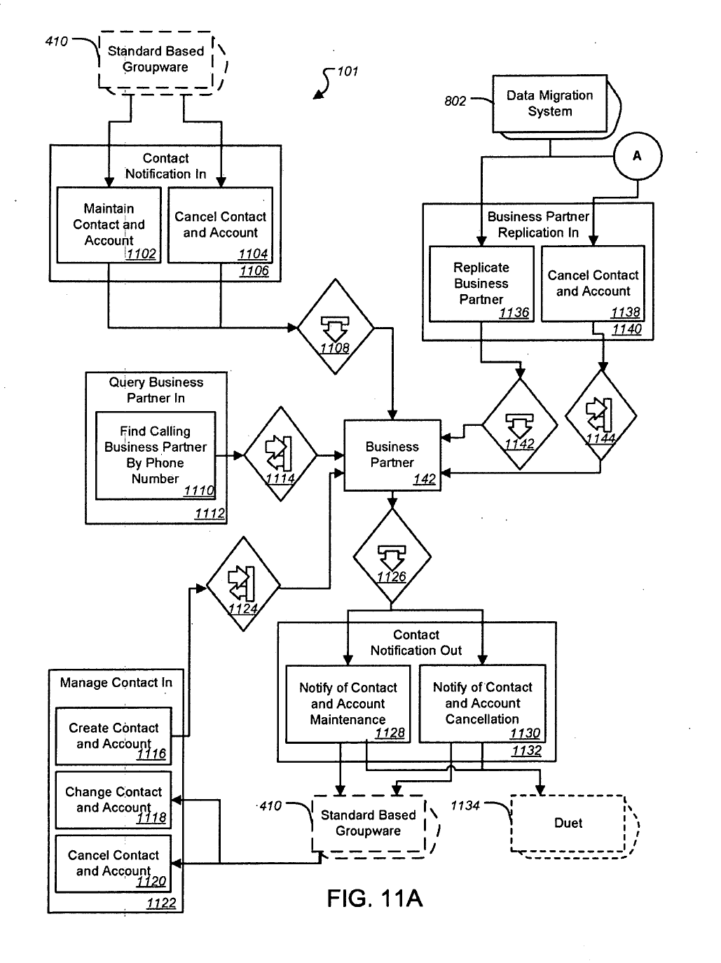

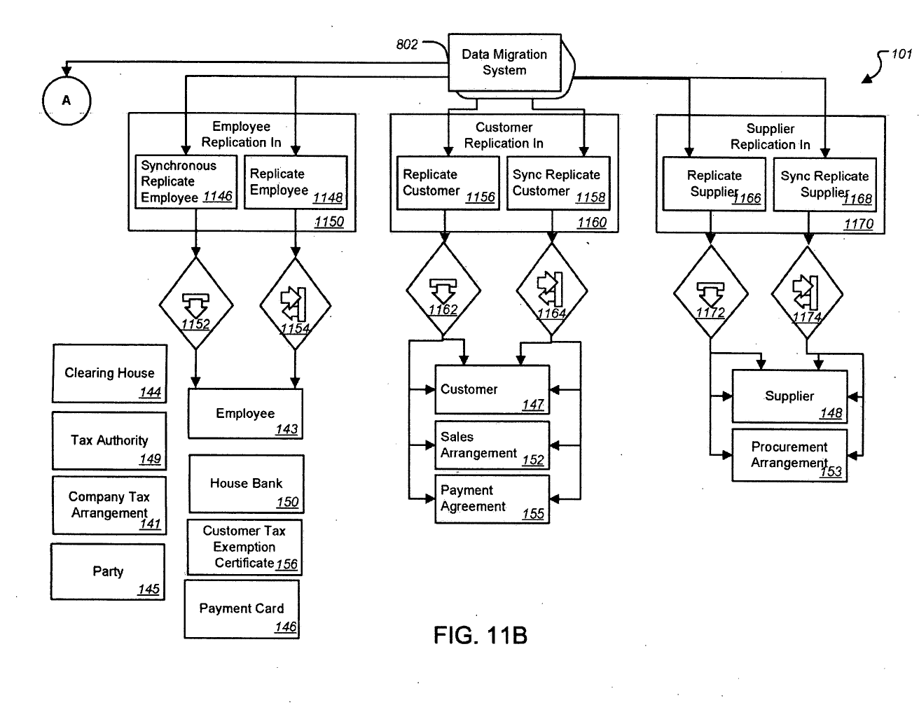

FIGS. 11A-B are block diagrams showing a business partner data management process component. The interactions can be invoked by an update to an update in the external Standard Based Groupware process component 410. The process component 410 invokes a Maintain Contact and Account operation 1102 or a Cancel Contract and Account 1104. The operations are included in a Contact Notification In interface 1106. The operations 1102 and 1104 use a Maintain Contact and Account based on Groupware Contact Transmission inbound process agent 1108 to update the Business Partner business object. In a similar fashion a Find Calling Business partner By Phone Number operation 1110 included in a Query Business Partner In interface 1112 can use a synchronous inbound process agent 1114 to update the Business Partner business object 142. In addition, a Create Contact and Account business object 1116, a Change Contact and Account business object 1118, or a Cancel Contact and Account business object 1120 (included in a Manage Contact In interface 1122) use a synchronous inbound process agent 1124 to update the Business Partner business object 142.

The Business Partner operation 142 uses a Notify of Contact outbound process agent 1126 to invoke a Notify of Contact and Account Maintenance operation 1128 or a Notify of Contact and Account Cancellation operation 1130. The operations 1128 and 1130 are included in a Contact Notification Out interface 1132. The operation 1128 updates the Standard Based Groupware process component 410 and the Duet process component 1134.

The Data Migration System process component 802 invokes a Replicate Business Partner operation 1136 or a Cancel Contact and Account operation 1138. The operations 1136 and 1138 are included in a Business Partner Replication In interface 1140. The operation 1136 uses a Replicate Business Partner inbound process agent 1142 to update the Business Partner business object 142. The operation 1138 uses a Cancel Contact synchronous inbound process agent 1144 to update the Business Partner business object 142.

As shown in FIG. 11B, the Data Migration System process component 802 can also invoke a Synchronous Replicate Employee operation 1146 or a Replicate Employee operation 1148. The operations 1146 and 1148 are included in an Employee Replication In interface 1150. The operation 1146 uses a Replicate Employee synchronous inbound process agent 1152 to update the Employee business object 143. The operation 1148 uses a Replicate Employee inbound process agent 1154 to update the Employee business object 143.

The Data Migration System process component 802 can also invoke a Replicate Customer operation 1156 or a Synchronous Replication Customer operation 1158. The operations 1156 and 1158 are included in an Customer Replication In interface 1160. The operation 1156 uses a Replicate Customer synchronous inbound process agent 1162 to update the Customer business object 147, the Sales Arrangement business object 152, or the Payment Agreement business object 155. The operation 1158 uses a Replicate Customer inbound process agent 1164 to update the Customer business object 147, the Sales Arrangement business object 152, or the Payment Agreement business object 155.

The Data Migration System process component 802 can also invoke a Replicate Supplier operation 1166 or a Synchronous Replication Supplier operation 1168. The operations 1166 and 1168 are included in a Supplier Replication In interface 1170. The operation 1166 uses a Replicate Supplier synchronous inbound process agent 1172 to update the Supplier business object 148 or the Procurement Arrangement business object 153. The operation 1168 uses a Replicate Supplier inbound process agent 1174 to update the Supplier business object 148 or the Procurement Arrangement business object 153.

In some implementations, the Data Migration System process component 101 can provide updates to the Party business object 145, the Customer Tax Exemption business object 156, the Clearing House business object 144, the Tax Authority business object 149, the House Bank business object 150, the Company Tax Arrangement business object 141, and the Payment Card 146.

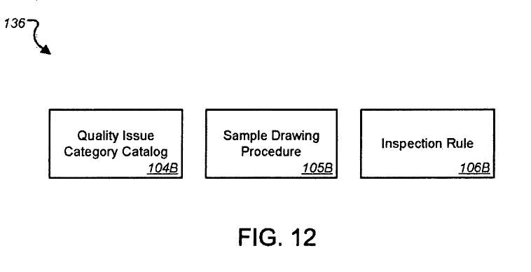

FIG. 12 is a block diagram showing an inspection master data management process component. The Inspection Master Data Management process component 136 handles the management of inspection-relevant master data, such as inspection rules and sample-drawing procedures, as well as the definition of quality-relevant catalogs. The Inspection Master Data Management process component 136 includes the Quality Issue Category Catalog 104B, the Sample Drawing Procedure 105B, and the Inspection Rule master data object 106B. The Quality Issue Category Catalog master data object 104B represents a structured catalog of categories that classifies quality-related issues for a particular quality aspect. The Sample Drawing Procedure master data object 105B represents a procedure that defines how samples are to be taken. It contains data for the sample-drawing frequency, sample size, and sample quantity. The Inspection Rule master data object 106B represents a rule that contains the specifications for an inspection. The inspection is used to check whether an object or procedure meets predefined requirements.

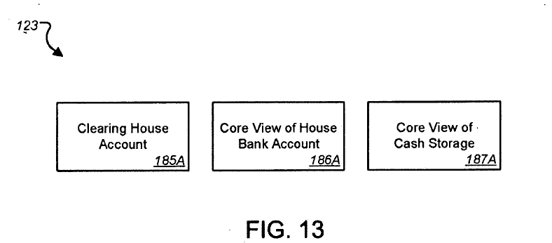

FIG. 13 is a block diagram showing a payment master data management process component 123. The payment master data management process component 123 handles the management of payment master data, such as clearing house accounts, that is used in different business areas. It also contains views of house bank accounts and cash storages. The payment master data management process component 123 includes a Clearing House Account master data object 185A, a Core View of House Bank Account master data object 186A, and a Core View of Cash Storage master data object 187A. The Clearing House Account master data object 185A represents a company-internal representation of an account that is set up and managed at a clearing house for card payments for the company. It is based on an agreement between the company and the clearing house. The Core View Of House Bank Account master data object 186A represents a view of a house bank account that contains identification, type, and currency data. The Core View of Cash Storage master data object 187A represents cash storage availability.

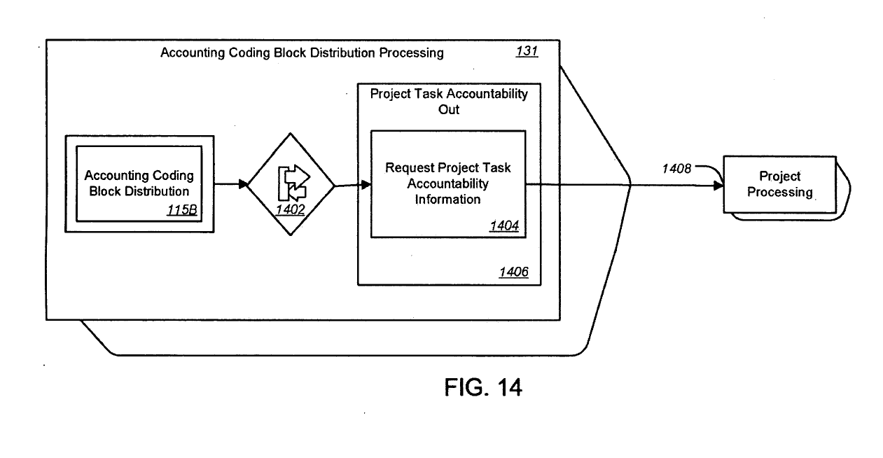

FIG. 14 is a block diagram showing an interaction with an accounting coding block distribution processing process component 131. The Accounting Coding Block Distribution Processing process component 131 includes the Accounting Coding Bock Distribution business object 115B. An update to either the business object 115B uses a Request Project Task Accountability Info from Accounting Coding Block Distribution to Project Processing synchronous outbound process agent 1402. The process agent 1402 invokes a Request Project Task Accountability Information operation 1404. The operation 1404 checks the project task accountability. The operation 1404 is included in a Project Task Accountability Out interface 1406. The Request Project Task Accountability Information operation 1404 can then send an update to A Project Processing process component 1408 regarding the Project Task.

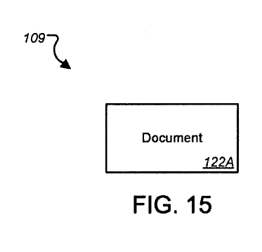

FIG. 15 is a block diagram showing a document management process component 109. The Document Management process component 109 includes the Document business object 122A. The Document business object 122A represents a carrier of unstructured information and additional control and monitoring information.

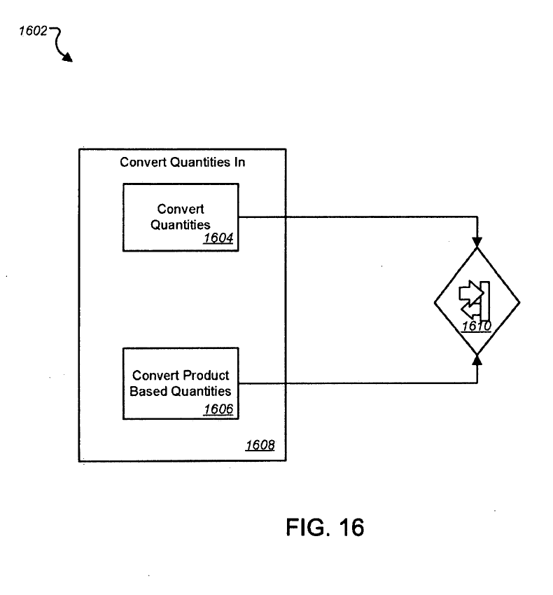

FIG. 16 is a block diagram showing a quantity conversion process component 1602. The Quantity Conversion process component 1602 is a reusable service that handles the conversion, calculation, and comparison of quantities and units of measurement. Product-specific conversion factors are maintained in the Product Master. For example, the conversion of quantities in gallons to liters can be stored in the Product Master. The quantities can be converted if requested by a Convert Quantities business object 1604 or a Convert Product Based on Quantities business object 1606. The business objects 1604 and 1606 are included in a Convert Quantities In interface 1608. The conversion can be transferred to other process components or system using a Convert Quantity synchronous inbound process agent 1610.

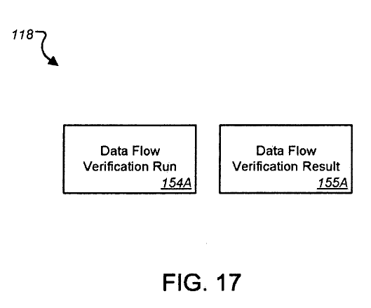

FIG. 17 is a block diagram showing a data flow verification process component 118. The Data Flow Verification process component 118 represents the act of verifying that the data flow between business objects has been carried out correctly. For example, the flow of data between business objects can be checked by examining the message exchange between sender and receiver, or by comparing the business object instances. The Data Flow Verification process component 118 includes a Data Flow Verification Run mass data run object 154A and a Data Flow Verification Result business process object 155A. The Data Flow Verification Run mass data run object 154A represents the specification of an automated run to verify the data flow between business objects. The Data Flow Verification Result business process object 155A represents the result of the verification process of the data flow between business objects.

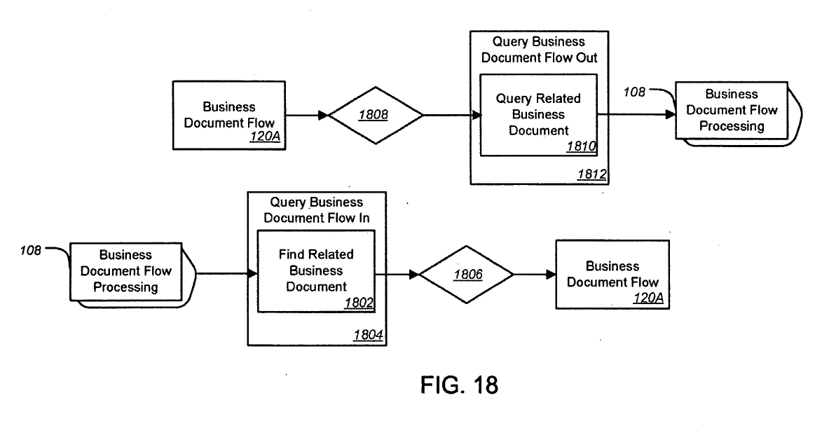

FIG. 18 is a block diagram showing an interactions with a business document flow processing process component 108. The Business Document Flow Processing process component 108 can invoke a Find Related Business Document operation 1802. The operation 1802 can find a business document related to a given business document. The operation 1802 is included in a Query Business Document Flow In interface 1804. The operation 1802 uses a synchronous Business Document Flow Processing to Business Document Flow outbound process agent 1806 to update the Business Document Flow business object 120A.

If the Business document Flow business object 120A receives an update, the business object 120A uses a synchronous Business Document Flow Processing to Business Document Flow inbound process agent 1808 to invoke a Query Related Business Document operation 1810. The operation 1810 can query a business document related to a given business document. The operation 1810 is included in a Query Business Document Flow Out interface 1812.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the invention or of what may be claimed, but rather as illustrating preferred embodiments of the invention. Certain features that are described in this specification in the context of separate embodiments may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer readable medium including program code for providing a set of entities for supporting message-based services using a service-oriented methodology for implementing an instance of a deployment unit, the medium comprising:
program code for storing an instance of a foundation layer for supporting one or more deployment units deployed in an application layer, and where the foundation layer implements a plurality of master data objects, the master data objects comprising:
a business folder structure definition master data object, wherein the business folder structure definition master data object represents a definition of the internal structure and constraints of business folders;
a logistics shift master data object, wherein the logistics shift master data object represents a period of working time in supply chain processes such as production, warehousing, and transportation that can be interrupted by breaks;
a core view of cash storage master data object, wherein the core view of cash storage master data object represents core view of cash storage;
a core view of house bank account master data object, wherein the core view of house bank account master data object represents a view of a house bank account that contains identification, type, and currency data;
a logistics break program master data object, wherein the logistics break program master data object represents a set of breaks in supply chain processes that are either scheduled at an absolute time of the day or scheduled relative to the start time of a shift;
a business plan variant specification master data object, wherein the business plan variant specification master data object represents a specification of external business conditions, business assumptions, business goals, and procedures of data collection for a business plan;
a logistics shift program master data object, wherein the logistics shift program master data object represents a set of shifts, organized as a generic program, in supply chain processes;
a service issue category catalog master data object, wherein the service issue category catalog master data object represents a structured directory of issue categories that group business transactions in customer service from an objective or a subjective point of view;
a service level objective master data object, wherein the service level objective master data object represents a measurable objective that specifies one or more conditions for fulfilling a service;
a procurement price specification master data object, wherein the procurement price specification master data object represents the specification of a price, a discount, or a surcharge for procurement of goods or services;
a sales price specification master data object, wherein the sales price specification master data object represents a specification of a price, a discount, or a surcharge for sales and service;
a sales price list master data object, wherein the sales price list master data object represents a combination of specifications for prices, discounts or surcharges in sales and service;
an installation point master data object, wherein the installation point master data object represents a physical or logical location at which a business object is installed during a certain period of time;
an installed base master data object, wherein the installed base master data object represents an installed base is a container that holds structured information of business components and their compositions;
a program master data object, wherein the program master data object represents an organizational center for managing a group of subprograms and projects;
a responsibility master data object, wherein the responsibility master data object represents a description of the specific rights and duties of a responsible acting agent;
a permanent establishment master data object, wherein the permanent establishment master data object represents an organizational center that represents a corporate division tied to a geographical location, and whose business activity is subject to uniform legal and fiscal processing;
a company master data object, wherein the company master data object represents a financially and legally-independent organizational center that is not tied to a geographical location, and that is registered under business law;
a segment master data object, wherein the segment master data object represents an organizational center that represents a corporate division for which financial information has to be published;
a cost center master data object, wherein the cost center master data object represents an organizational center where costs are incurred and for which costs are recorded separately;
a job master data object, wherein the job master data object represents the type of a position;
a profit center master data object, wherein the profit center master data object represents an organizational center that represents an area of a company for which a separate period-based profit is determined and used for profit-oriented analysis and management of the area activities;
a reporting line unit master data object, wherein the reporting line unit master data object represents an organizational center in the personnel reporting line of a company;
a functional unit master data object, wherein the functional unit master data object represents an organizational center that is responsible for the planning, execution, and administration of business process steps;
an organizational center template master data object, wherein the organizational center template master data object represents a collection of pre-defined information used to create a new organizational center;
a company tax arrangement master data object, wherein the company tax arrangement master data object represents an agreement between a company and a tax authority regarding the declaration and payment of taxes;
a position master data object, wherein the position master data object represents an organizational element within the organizational structure of an enterprise;
an organizational center master data object, wherein the organizational center master data object represents a business unit in an organizational structure of a company within the extended enterprise;
a company financials process control master data object, wherein the company financials process control master data object represents information about a company that is used in financial processes;
a supply planning area master data object, wherein the supply planning area master data object represents an area for which a separate planning ensures the availability of products on time;
a location master data object, wherein the location master data object represents a geographical place;
a transportation lane master data object, wherein the transportation lane master data object represents a relationship between two locations or transportation zones that specifies the materials that can be transported between locations or transportation zones, and the means of transport that can be used;
a transportation zone master data object, wherein the transportation zone master data object represents a zone containing geographical locations considered collectively for modeling or planning transportation routes or transportations;
a storage behavior method master data object, wherein the storage behavior method master data object represents a set of rules that defines the manner in which a storage location is managed;
a logistics source and destination determination rule master data object, wherein the logistics source and destination determination rule master data object represents a rule for determining the logistics source for inventory retrieval or the logistics destination for inventory placement for a specific logistics area or location;
a logistics area master data object, wherein the logistics area master data object represents a freely definable area within a location providing detailed physical and operational information used for storage and production;
a source of supply master data object, wherein the source of supply master data object represents a source for the internal and external procurement and the internal production of one or more products;
an supply quota arrangement master data object, wherein the supply quota arrangement master data object represents an arrangement that specifies how material demands or material issues are distributed to different sources of supply, business partners, or internal organizational units;
a product category hierarchy master data object, wherein the product category hierarchy master data object represents a hierarchical arrangement of product categories according to objective business aspects;
a product property list master data object, wherein the product property list master data object represents a list of properties from product property libraries that are adjusted to suit one or more products;
a product property library master data object, wherein the product property library master data object represents a library of product properties that are reused to further describe instances or groups of business objects in specific application areas;
an access group master data object, wherein the access group master data object represents a group of identities for which access control is specified in a certain context;
an identity master data object, wherein the identity master data object represents the uniqueness of a human person or non-human subject in a uniform way;
an access control list master data object, wherein the access control list master data object represents an access control list is a list of access groups that have access to the entire host object during a validity period;
a compensation component type master data object, wherein the compensation component type master data object represents a description of the employee compensation components in the context of human resources;
an employment master data object, wherein the employment master data object represents a relationship that comes into being by virtue of one or more valid work agreements;
a work agreement master data object, wherein the work agreement master data object represents a contract between employer and employee that obligates the employee to provide his or her labor and the employer to provide the agreed compensation;
a material procurement process control master data object, wherein the material procurement process control master data object represents a process-driven view that contains information about a material that is used in procurement-relevant processes;
a material supply planning process control template master data object, wherein the material supply planning process control template master data object represents a template that simplifies the maintenance of material master data used to control procurement planning;
a material supply planning process control master data object, wherein the material supply planning process control master data object represents a process-driven view that contains information about a material that is used in supply planning processes;
a service product financials process control master data object, wherein the service product financials process control master data object represents a process-driven view that contains information about a service that is used in financial processes;
a material inventory process control template master data object, wherein the material inventory process control template master data object represents a template that simplifies the maintenance of material master data used to control several logistic processes;
a service product procurement process control master data object, wherein the service product procurement process control master data object represents a process-driven view that contains information about a service that is used in procurement-relevant processes;
a material procurement process control template master data object, wherein the material procurement process control template master data object represents a template that simplifies the maintenance of material master data used in procurement-relevant processes;
a material financials process control template master data object, wherein the material financials process control template master data object represents a template that simplifies the maintenance of material master data used to process in financials;
a service product procurement process control template master data object, wherein the service product procurement process control template master data object represents a template that simplifies the maintenance of service product master data used in procurement-relevant processes;
a warranty master data object, wherein the warranty master data object represents a guarantee to vouch for defects or faults in the product purchased that is valid for a specific period of time;
an individual material service process control master data object, wherein the individual material service process control master data object represents a process-driven view that contains information about an individual material that is used in customer service processes;
an material sales process control template master data object, wherein the material sales process control template master data object represents a template that simplifies the maintenance of material master data used to control presales, sales, and customer service processes;
a individual material master data object, wherein the individual material master data object represents a tangible product that occurs only once in the real world and is therefore uniquely identifiable;
a material financials process control master data object, wherein the material financials process control master data object represents a process-driven view that contains information about a material that is used in financial processes;
a service product procurement process control template master data object, wherein the service product procurement process control template master data object represents a template that simplifies the maintenance of service product master data used in procurement-relevant processes;
a service product financials process control template master data object, wherein the service product financials process control template master data object represents a template that simplifies that simplifies the maintenance of service product master data used to processes in financials;
a material availability confirmation process control master data object, wherein the material availability confirmation process control master data object represents a process-driven view that contains information about a material used in availability confirmation processes;
a warranty service process control master data object, wherein the warranty service process control master data object represents a process-driven view that contains information about a warranty that used in customer service processes;
a material sales process control master data object, wherein the material sales process control master data object represents a process-driven view that contains information about a material used in presales, sales, and customer service processes;
a service product template master data object, wherein the service product template master data object represents a template that contains service product data relevant for presales, sales, and financials processes;
a material template master data object, wherein the material template master data object represents a template that contains material data relevant for presales, sales, financials, supply planning, and availability confirmation processes;
a material master data object, wherein the material master data object represents a tangible product, such as a sellable article, packaging, auxiliary material, and expendable supplies, that can be created and then represents a business value;
a service product sales process control template master data object, wherein the service product sales process control template master data object represents a template that simplifies the maintenance of service product master used to control presales, sales, and customer service processes;
a material availability confirmation process control template master data object, wherein the material availability confirmation process control template master data object represents a template that simplifies the maintenance of material master data when executing an availability check;
a service product master data object, wherein the service product master data object represents an intangible product that describes the provision of a service;
a service product sales process control master data object, wherein the service product sales process control master data object represents a process-driven view that contains information about a service that is used in presales, sales, and customer service processes;
an identified stock master data object, wherein the identified stock master data object represents a subset of a material that shares a set of common characteristics, is logistically handled separately from other subsets of the same material and is uniquely identified;
a material inventory process control master data object, wherein the material inventory process control master data object represents a process-driven view that contains information about a material that is used in logistics processes;
a procurement arrangement master data object, wherein the procurement arrangement master data object represents an arrangement between a strategic purchasing unit and a supplier that is used for procurement transactions;
a house bank master data object, wherein the house bank master data object represents an organization that provides banking services for the company;
a supplier product category life cycle master data object, wherein the supplier product category life cycle master data object represents a representation of the supplier life cycle that contains information about the status of supplier development and the product category delivered by that supplier;
an employee master data object, wherein the employee master data object represents a person who contributes or has contributed to the creation of goods or services for a company;
a customer master data object, wherein the customer master data object represents a business partner to whom materials or services are offered or provided;
a clearing house master data object, wherein the clearing house master data object represents an organization that provides services for the settlement of payment card payments;
a payment agreement master data object, wherein the payment agreement master data object represents an agreement between a company and a business partner on the handling of payments;
a tax authority master data object, wherein the tax authority master data object represents an authority that collects and administers taxes;
a communication arrangement master data object, wherein the communication arrangement master data object represents an arrangement between the system owner and a business partner, containing the communication settings for xml messaging, file-based communication and form-based communication via output channels like print, email and fax;
a payment card master data object, wherein the payment card master data object represents a card that facilitates the card owner to purchase goods or services from merchants or companies affiliated to clearing houses, without cash payment;
a supplier master data object, wherein the supplier master data object represents a business partner who offers or provides materials or services;
a sales arrangement master data object, wherein the sales arrangement master data object represents an arrangement between a sales organization and a customer that is used for sales transactions; and
a business partner master data object, wherein the business partner master data object represents a person, an organization, or a group of persons or organizations, in which a company has a business interest.

2. The medium of claim 1, wherein the master data objects further comprise:
a quality issue category catalog master data object, wherein the quality issue category catalog master data object represents a structured catalog of categories that classifies quality-related issues for a particular quality aspect;
a sample drawing procedure master data object, wherein the sample drawing procedure master data object represents a procedure that defines how samples are to be taken;
a inspection rule master data object, wherein the inspection rule master data object represents a rule that contains the specifications for the inspection;
a exchange rate master data object, wherein the exchange rate master data object represents the relationship in which one currency can be exchanged for another currency at a specified time;
a bank directory entry master data object, wherein the bank directory entry master data object represents an entry for a bank in a directory of banks;
an production bill of operations master data object, wherein the production bill of operations master data object represents a description of a production process for manufacturing a product;
a production bill of material master data object, wherein the production bill of material master data object represents a complete and structured list that defines and describes the components that are used in the production of a material including all its variants;
a released planning production model master data object, wherein the released planning production model master data object represents a released version of a production model that contains the production bill of operations and production bill of material data used in the planning of a production process;
a production model master data object, wherein the production model master data object represents a model of a production process that is defined by a network of production segments;
a production segment master data object, wherein the production segment master data object represents a part of a production process specified by a network of operations and assigned materials for the production of a material;
a released execution production model master data object, wherein the released execution production model master data object represents a released version of a production model that contains the production bill of operations and production bill of material data used for the execution of a production process;
a logistic unit usage master data object, wherein the logistic unit usage master data object represents a logistics purpose for which logistic units are grouped;
a packing bill of material master data object, wherein the packing bill of material master data object represents a complete and structured list of components that defines the packing structure of logistic units;
a logistic unit master data object, wherein the logistic unit master data object represents an item established for logistics operations, such as storage, movement, and packing;
a clearing house account master data object, wherein the clearing house account master data object represents a company-internal representation of an account that is set up and managed at a clearing house for card payments for the company;
a site logistics process model master data object, wherein the site logistics process model master data object represents a model of site logistics process that is specified by a sequence of site logistics process segments;
a site logistics process segment master data object, wherein the site logistics process segment master data object represents a part of a logistics process specified by a net of operations for packing, moving and checking of goods;
a site logistics bill of operations master data object, wherein the site logistics bill of operations master data object represents a description of a process for a company internal movement of goods, goods receipt, or goods issue;
a released site logistics process model master data object, wherein the released site logistics process model master data object represents a released version of a site logistics process model that contains all elements used for defining and describing the execution of a site logistics process;
a document master data object, wherein the document master data object represents a carrier of unstructured information and additional control and monitoring information;
a product requirement specification template master data object, wherein the product requirement specification template master data object represents a template that defines the fundamental structure of product requirement specifications in logistics processing in the form of properties and texts
a resource group master data object, wherein the resource group master data object represents a grouping of individual resources that provide similar services or have similar physical and functional characteristics;
a resource operating time template master data object, wherein the resource operating time template master data object represents a template of an operating time definition that contains all information used to maintain the operating times for multiple resources;
an equipment resource master data object, wherein the equipment resource master data object represents an equipment resource is a permanently installed operating facility or a group of identical operating facilities that has the capacity to provide services;
a labor resource master data object, wherein the labor resource master data object represents an employee or a group of employees with the same skills and qualifications with the capacity to operate specific devices or to perform specific tasks; and
a vehicle resource master data object, wherein the vehicle resource master data object represents a means of transportation or a group of identical means of transportation that has the capacity to provide transportation services.

3. The medium of claim 1, wherein the foundation layer further implements a plurality of business process objects, the business process objects comprising:
an output determination rule business process object, wherein the output determination rule business process object represents a rule defining which set of output parameters to use during output;
a product requirement specification business process object, wherein the product requirement specification business process object represents a collection of requirements for a product used in a specific business context;
a change document business process object, wherein the change document business process object represents a record of changes made to a object instance;
an organizational view of project business process object, wherein the organizational view of project business process object represents the organizational data of a project;
an engineering change order business process object, wherein the engineering change order business process object represents a set of instructions to make changes to a number of objects from the areas of engineering or production;
an engineering change case business process object, wherein the engineering change case business process object represents a collection of documents, references, and decisions used to identify a potential solution to problems that initiate an engineering change;
a key performance indicator business process object, wherein the key performance indicator business process object represents a quantifiable business performance factor;
a key performance indicator evaluation business process object, wherein the key performance indicator evaluation business process object represents a user-specific, time-dependent, and parameter-based evaluation of a key performance indicator that results in a value;
a sourcing allocation business process object, wherein the sourcing allocation business process object represents the assignment of a product quantity to a source of supply or a supply quota arrangement item that has to be internally or externally procured or internally produced;
a company tax exemption certificate business process object, wherein the company tax exemption certificate business process object represents a certificate issued by a company to a supplier claiming exemption from product tax for purchases;
a customer tax exemption certificate business process object, wherein the customer tax exemption certificate business process object represents a certificate sent by a customer to a company claiming exemption from tax on sales/purchases;
an appointment activity business process object, wherein the appointment activity business process object represents a planned or unplanned activity that is maintained in a calendar of an employee of a company;
an email activity business process object, wherein the email activity business process object represents an activity that contains information communicated via the internet or an internal groupware server; it can include texts and attachments;
a phone call activity business process object, wherein the phone call activity business process object represents an activity that records telephone interactions that are undertaken by employees on behalf of their company;
an activity task business process object, wherein the activity task business process object represents a task used in activity management containing information about anything an employee needs to do within a certain time frame, and which can be related to a business partner;
a fax activity business process object, wherein the fax activity business process object represents an activity that contains documents or graphics transmitted via a telecommunications facility by an employee of a company; and
a letter activity business process object, wherein the letter activity business process object represents an activity that records a message, written on paper by an employee of a company on the company's behalf.

4. The medium of claim 1, wherein the foundation layer further implements:
a go live checklist transformed object, wherein the go live checklist transformed object represents a list of business options for a business system's customer/prospect to check or further maintain in order to adjust the business system to their specific business needs;
a used address transformed object, wherein the used address transformed object represents the address that is currently being used by a business object node that can have multiple references for its address;
a property type system view transformed object, wherein the property type system view transformed object represents a view that provides both aggregated and detailed information about property type systems;
a sourcing list transformed object, wherein the sourcing list transformed object represents a list of sources for the internal and external procurement and the internal production of one or more products;
a party transformed object, wherein the party transformed object represents a business partner or an organizational center;
a business document flow transformed object, wherein the business document flow transformed object represents a view on the set of all preceding and succeeding business documents for a given business document;
an activity transformed object, wherein the activity transformed object represents a structured view of various types of activities, such as letter, e-mail, or fax activities, for the purpose of planning and documenting all actions and interactions related to business partners;
a resource transformed object, wherein the resource transformed object represents an asset that contributes to the sourcing, production or delivery of a product;
an archiving run mass data run object, wherein the archiving run mass data run object represents specification of an automated run that archives business object data;
an archivability check run mass data run object, wherein the archivability check run mass data run object represents a specification of an automated run that checks the archivability of business object data;
a data destruction run mass data run object, wherein the data destruction run mass data run object represents specification of an automated run that destroys business object data; and
a data flow verification run mass data run object, wherein the data flow verification run mass data run object represents a specification of an automated run to verify that the data flow between business objects has been carried out correctly.

5. The medium of claim 1, where the foundation layer further implements a plurality of dependent objects, the dependent objects comprising:
an operating hours dependent object, wherein the operating hours dependent object represents a generic description of time periods based on a recurrence pattern, during which operations are performed;
a business folder dependent object, wherein the business folder dependent object represents a folder for collecting and organizing information relating to a business subject according to customer needs;
an attachment folder dependent object, wherein the attachment folder dependent object represents a collection of all documents attached to a business object or a part of a business object;
a personal address dependent object, wherein the personal address dependent object represents an address of a person;
a payment control dependent object, wherein the payment control dependent object represents an agreement between a company and a business partner on processing payments for an individual business transaction;
a communication dependent object, wherein the communication dependent object represents a set of communication data that does not include a postal address;
a text collection dependent object, wherein the text collection dependent object represents a text collection is a set of multilingual textual descriptions including formatting information for a business object or a part of a business object;
a market segment dependent object, wherein the market segment dependent object represents a sector of the overall market that is characterized by a particular supply and demand situation and that exhibits specific customer and product characteristics as well as characteristics for regional and organizational classification;
a cash discount terms dependent object, wherein the cash discount terms dependent object represents the modalities agreed on by business partners for the payment of goods delivered or services provided;
a workplace address dependent object, wherein the workplace address dependent object represents an address of a person's workplace within an organization;
an address dependent object, wherein the address dependent object represents the data that describes the addressee, postal address, and communication data;
a partner address dependent object, wherein the partner address dependent object represents an address of an organization or a group, or the address of a person;
a financial audit trail documentation dependent object, wherein the financial audit trail documentation dependent object represents a uniform documentation of the changes to receivables and payables and financial transactions linked to a business transaction for audit purposes;
an organization address dependent object, wherein the organization address dependent object represents an address of an organization, a group, or a similar entity;
a payment explanation dependent object, wherein the payment explanation dependent object represents a reason/reasons for a payment with reference to one or more business documents such as contracts, invoices, credit memos, or sales orders;
a property valuation list dependent object, wherein the property valuation list dependent object represents a list of instance or group-specific properties of an object, along with their valuations;
a property type system dependent object, wherein the property type system dependent object represents a consistent system of object properties, along with their definitions and underlying property data types;
a price and tax calculation dependent object, wherein the price and tax calculation dependent object represents the summary of the determined price and tax components for a business case;
a tax calculation dependent object, wherein the tax calculation dependent object represents the summarization of the determined and calculated tax elements of a business case;
a price specification dependent object, wherein the price specification dependent object represents a specification of a price, a discount, or a surcharge for sales, service, and purchasing;
a price calculation dependent object, wherein the price calculation dependent object represents the summary of the determined price components for a business case;
an output control dependent object, wherein the output control dependent object represents a set of settings for form-based output via channels like print, email and fax; it controls master data dependent output;
a controlled output request dependent object, wherein the controlled output request dependent object represents a controlled output request is a controller of output requests and processed output requests related to the hosting business object;
a storage control dependent object, wherein the storage control dependent object represents a specification of inventory items' constraints and inventory items' rules applied in a storage location;
a product property valuation list dependent object, wherein the product property valuation list dependent object represents a list of product properties of an object with their valuations;
a product property type system dependent object, wherein the product property type system dependent object represents a consistent system of product properties, along with their definitions and underlying property data types;
a business process chain assignment dependent object, wherein the business process chain assignment dependent object represents an assignment of a business object node to a business process chain; and
an accounting coding block distribution dependent object, wherein the accounting coding block distribution dependent object represents an accounting coding block distribution is the distribution of coding blocks to enterprise resources changes.

6. The medium of claim 1, wherein the foundation layer further implements a plurality of technical objects, the plurality of technical objects comprising:
a catalog access specification technical object, wherein the catalog access specification technical object represents a specification to access a web-based catalog that contains a uniform identifier including parameters and control settings;
a output request technical object, wherein the output request technical object represents a request to get an output document related to a business object for front-end preview; the output request supports form-based, front-end output of a business object;
a task technical object, wherein the task technical object represents a task is a request to perform an action that can be executed in order to achieve a business or technical objective;
a catalog access result technical object, wherein the catalog access result technical object represents a result from a catalog that contains user-requested data, which is transferred from a catalog to a business document;
a process integration inbound error technical object, wherein the process integration inbound error technical object represents an error that occurred during the inbound message processing;
a cross product catalog search technical object, wherein the cross product catalog search technical object represents a search across product catalogs that contains the search text and the maximum time allowed for the search and references the result;
an application log technical object, wherein the application log technical object represents a collection of textual information automatically created by the application that describes the activities of a business object;
a transactional planning data buffer control technical object, wherein the transactional planning data buffer control technical object represents a means of controlling the transactional buffer for planning data;
a software problem report technical object, wherein the software problem report technical object represents a report about an incident in a sap centric it solution;
a property type system value help technical object, wherein the property type system value help technical object represents a value-help enabler for nodes of the property type system dependent object;
a data flow verification result technical object, wherein the data flow verification result technical object represents a result of the verification process for the data flow between business objects;
an output task technical object, wherein the output task technical object represents a request to send a document to one specified output channel;
an output error technical object, wherein the output error technical object represents an error that occurs during the processing of an output task;
a file input control technical object, wherein the file input control technical object represents a file input control is an object that initiates and controls the technical processing of inbound files by the knowledge management adapter service;
a payment card payment authorization technical object, wherein the payment card payment authorization technical object represents an authorization for a payment made using a payment card;
a number range technical object, wherein the number range technical object represents a range of numbers that are delimited by an upper and lower boundary, and generated in a consecutive order;
a document template technical object, wherein the document template technical object represents is a template, which defines the content, format, placeholders and the structure for creating new documents having a uniform style;
a business rule expression technical object, wherein the business rule expression technical object represents an expression that specifies the business logic of a business rule in a formal way; business rule expressions may be simple such as a constant, case or range or complex;
a business rule parameter definition technical object, wherein the business rule parameter definition technical object represents the definition of a formal parameter that can be used as an input or output parameter in one or more business rule definitions and in one or more business rule expressions; and
a business rule definition technical object, wherein the business rule definition technical object represents definition of a business rule comprising the name and the signature.

7. The medium of claim 1, wherein:
the instance of the foundation layer is a first instance of the foundation layer stored on a first hardware platform; and
a second instance of the foundation layer is stored on a second hardware platform that is distinct and separate from the first hardware platform; and
where each of these instances of the foundation layer is separately deployed in its particular entirety on each of the first and second hardware platforms.

8. The medium of claim 7, wherein:
a first application software implemented in one or more first deployment units is also deployed on the first hardware platform; and
a second application software implemented in one or more second deployment units is also deployed on the second hardware platform, the second deployment units being distinct and separate from the first deployment units.

9. The medium of claim 8, wherein:
the one or more first deployment units comprise a first plurality of business objects and the one or more second deployment units comprise a second plurality of business objects; and
the first plurality of business objects and the second plurality of business objects have no business objects in common.

10. The medium of claim 8, further comprising:
program code for storing a repository of resource descriptions, the repository including a standards-based description of business objects in the foundation layer.

11. A computer readable medium including program code for providing a set of entities for supporting message-based services using a service-oriented methodology for implementing an instance of a deployment unit, the medium comprising:
program code for storing an instance of a foundation layer for supporting one or more deployment units deployed in an application layer, and where the foundation layer implements a plurality of process components, the process components comprising:
a software problem reporting process component that is used for collecting context data in a sap centric it solution in case of an incident, summarizing these data in a software problem report, and sending the report to the appropriate service desk
an information life cycle management process component that defines and executes data retention policies;
a customer service master data management process component that the administrates and maintains master data used in customer service;
a property management process component that the management of properties along with their valuations;
a business configuration process component that is the business configuration covering the whole process of business setup and business adaptation;
a price master data management process component that the managing of prices and price-related data for sales and procurement processes;
an installed base data management process component that manages and structures installed objects;
a data flow verification process component that performs the act of verifying that the data flow between business objects has been carried out correctly;
an organizational management process component that handles the provision of central and unified organizational structures of the enterprise and its collaborative partners;
a date and time process component that is used for the conversion, calculation, and comparison of time points, durations, and time periods;
a pricing engine process component that handles the processing of price and tax calculation;
an engineering change processing process component that handles the processing of changes to master data used in the product life-cycle phases engineering and manufacturing;
an input and output management process component that covers form-based input and output as well as structured file import and export;
a payment authorization process component that is used to process the authorization request for a payment made using a payment card, at the clearing house;
a key performance indicator management process component that handles the management of key performance indicators of a company along with their evaluations;
a location data management process component that the management of the master data used for physical locations;
an application log administration process component that handles the administration of application logs;
a logistics area and storage management process component that handles the maintenance of logistics area master data along with storage methods, as well as placement and retrieval rules for inventory;
a source of supply determination process component that handles the maintenance of and access to sources of supply and quota arrangements for external and internal procurement processes;
a currency conversion process component that is used for conversion of monetary amounts from one currency to another;
a product property management process component that handles the management of product properties along with their valuations;
a change document management process component that handles the management of change documents;
an identity management process component that handles identity management and deals with identifying individuals in a system landscape and controlling their access by associating user rights and restrictions;
a human capital master data management process component that the management of work agreements, employments, and human capital master data that is used in different human capital management areas;
a product data maintenance process component that handles the maintenance of product data that describes a company's tangible and intangible products, and that is used to control business processes;
a business partner data management process component that handles the management of the business partner master data of a company;
an inspection master data management process component that handles the management of inspection-relevant master data;
a financial market data management process component that handles the management of financial market data; this data can be obtained from generally accepted external providers;
an address data management process component that handles the management of addresses and communication data;
a production model management process component that handles the maintenance and releasing of master data used for production planning and production execution;
a logistic unit data management process component that handles the maintenance of master data used when handling or using logistic units, including grouping and packing instructions;
a number range process component that a reusable service that facilitates the generation of consecutive numbers and validates externally provided numbers;
a logistics shift administration process component that handles the administration of logistics shifts and breaks;
a payment master data management process component that handles the management of payment master data;
a business document flow processing process component that handles the collecting of the entire sequence of documents related to a business transaction;
a site logistics model management process component that handles the maintenance and releasing of master data used for the site logistics execution;
an accounting coding block distribution processing process component that handles the registration and checking of all accounting objects that can be assigned in a source document for a business transaction;
a document management process component that manages documents used in business processes;
an activity management process component that handles the recording of business activities and tasks undertaken on behalf of the company;
a quantity conversion process component that is used for conversion, calculation, and comparison of quantities and units of measurement;
a business rules management process component that handles the management of business rules;
a product requirement specification processing process component that handles the creation, evaluation, and processing of requirements and specifications along the value-chain for products in particular business scenarios; and
a resource data management process component that handles the management of the master data used to define a resource.
